(19) United States
(12) Patent Application Publication
(10) Pub. No.: US 2007/0202485 A1
(43) Pub. Date: Aug. 30, 2007

(54) Methods And Apparatus For Preserving The Endothelium In Isolated Hollow Organs And Biological Vessels

(75) Inventors: Stephan Nees, Munchen (DE); Friderike Nees, Munchen (DE)

Correspondence Address: MAYER, BROWN, ROWE & MAW LLP, 71 S. WACKER, CHICAGO, IL, 60606, US

(73) Assignee: BIOTEST AG, 63303 DREIEICH GERMANY (DE)

(21) Appl. No.: 10/560,407

(22) PCT Filed: Jun. 11, 2004
(86) PCT No.: PCT/EP04/06309

§ 371 Date: Nov. 8, 2006

(30) Foreign Application Priority Data
Jun. 13, 2003 (DE) 103-26-764.6

(51) Int. Cl. A01N 1/02

(52) U.S. Cl. 435/1.1; 435/284.1

(57) ABSTRACT

The invention relates to a method and an apparatus for the endothelium-preserving treatment of isolated hollow organs, especially biological vessels such as blood vessels and lymphatic vessels by means of endothelium-protective perfusates or incubation solutions containing at least 0.1 percent by weight of native albumin and a nutrient substrate, preferably L-glutamine. Also disclosed are the use of the endothelium-protective perfusates for preparing hollow organs or biological vessels as a transplant for the treatment of organ diseases or vascular diseases, the use thereof for repairing endothelial lesions in isolated hollow organs and/or biological vessels, and the use thereof for preserving organs and/or vessels.

### BACKGROUND OF THE INVENTION

The present invention relates to a method and an apparatus for the treatment and preservation of endothelial tissue in isolated hollow organs, in particular in isolated biological vessels such as blood vessels and lymphatic vessels, by using an albumin-containing endothelium-protective perfusion solution or incubation solution, the use of such an endothelium-protective perfusion solution for the preparation of hollow organs or biological vessels as grafts for the treatment of organ or vessel diseases, its use for repair of endothelial lesions in isolated hollow organs and/or biological vessels and its use for preservation of organs and/or vessels.

An occlusion of blood vessels that is caused by arteriosclerosis is one reason for a plurality of organ diseases in Western countries. A transplantation of vessels, i.e. the replacement of morbid, narrowed or closed biological vessels by healthy vascular substitutes has therefore a high clinical significance for the treatment of such diseases. In the Federal Republic of Germany, about 200,000 people per year die due to heart attack resulting from an arteriosclerotic occlusion of one or more coronary arteries.

A further widely distributed disease pattern which is caused by arteriosclerosis relates to peripheral arterial abstractive disease (pAVK). Approximately 5-10% of the adults suffer from peripheral arterial circulatory disorders, which require dramatic sanctions with the patients, such as an amputation of limbs in about 35,000 people per year in the Federal Republic of Germany. By a timely and surgically conducted bypassing of such abnormally mutated biological vessels with a suitable vascular substitute, the patients or their limbs can be treated or rescued, even in such cases.

For bypass surgeries, different vascular substitute materials have been utilized, which can be divided into three main groups depending on their origin: 1. autologous (=derived from the own body) vascular implants, 2. biological vascular implants and 3. synthetic vascular implants. In this regard, the first two vascular substitute materials can be referred to as “biological vascular substitutes”. The biological implants can be divided into homologous (=isolated from the same species) and heterologous (=isolated from another species) vascular implants. The synthetic implants are usually alloplastic (Greek “allo”=different, foreign) vascular substitutes, for which preferably inert, porous synthetics such as polyester (Dacron®) or polytetrafluoroethylene (PTFE; Teflon®), are used.

The most important and most preferred starting materials in vascular surgery, in particular in bypass operation, are autologous implants. In biological vessels Vena saphena magna or Arteria thoracica interna (=Arteria mammaria int.) are preferably used. Both vessels are preferably utilized in coronary surgery. The use of autologous vessels, in contrast to other vascular implants, provides the best results with regard to the so-called “opening rates”. This includes the number of open vessels after a particular period upon vascular transplantation.

In coronary surgery almost 80-95% of the Arteria mammaria int. bypasses but only 65-80% of the venous bypasses used are still open after a period of 5 years. In this respect, it is important to note that 20% of the implanted biological vessels are already dangerously occluded or completely closed within the first year after transplantation. Re-surgeries will become necessary after 10 years in approximately 8-16% of the cases of venous bypasses and in approximately 8% of the cases of Arteria mammaria int. bypasses.

These numbers make clear that even an autologous vascular substitute, although it has several advantages in comparison to other kind of vascular implants, is associated with considerable loss of functions. This loss of functions is based on vascular occlusions. Therefore, an autologous vascular substitute can often not provide a satisfying result for transplantation. Because of such observed loss of functions of the implanted vessels and the complications associated therewith, there is a need to improve the usual surgical practice. Open and functional biological vessels are vital for the organism and essential for survival of the patient. The inventors of the present invention have observed that one important reason for the acute occlusion (thrombosis) of biological vessels and restenosis caused by intimal wall thickening and the loss of functions associated therewith is based on the common handling of biological vessels during vascular transplantations in surgical practice.

If one investigates surgically obtained Vena saphena segments that were stored in conventional crystalloid solutions (e.g. saline, Bretschneider solution) until transplantation, one will find an extremely affected luminal endothelium in the vessels. The endothelium (endothelial tissue) forms the inner surface of any biological vessel and organ system. The endothelium is a part of the intima (=Tunica intima). The intima consists of a endothelial monolayer and Stratum subendotheliale (casual connective tissue including subendothelial pericytes that were discovered by the inventors) as well as mounted Membrana elastica interna and accomplishes important biological functions which are essential for the maintenance of the function of blood vessels. In principle, the endothelium must be regarded as the actual blood reservoir of the body.

More than 50% of the bypass vessels routinely used do not contain any luminal endothelium. The reason is because autologous vascular implants are treated with conventional incubation solutions such as saline (“physiological saline solution”) or Bretschneider solution prior to vascular transplantation, which, sometimes, is associated with strong mechanical stress so as to make the vessels free of blood and to verify their impermeability. For example, organs are usually treated with University of Wisconsin (UW) solution, Carolina Rins solution and HTK solution during transplantation without being aware of the fact that the endothelium may have an important function. It was found by the inventors of the present invention that such a treatment procedure which has been commonly utilized in practice, may result in a remarkable damage of the endothelial function, resulting in a total destruction of the endothelial tissue. However, the damage or destruction of endothelial tissue is one reason why biological vascular and organ implants may become obstructed subsequent to their transplantation, just as mentioned above.

Following treatment of the vessels with saline, the biological vessels are subjected to strong mechanical operational stress because the vessels are commonly attached to a thick cannula and treated with saline solution using a connected syringe under uncontrollable high pressure. Subsequently, the vessel is pulled down from the cannula in order to find branches of vessels from which, in this moment, liquid leaves the vessel so that the branches can be directly ligated with suitable surgery clamps. Finally, the vessel segment, which is prepared for transplantation purposes, is subjected in its entire length, under high pressure for testing the impermeability which is associated with a “blowing up” of the isolated vessel. Due to the high pressure that is supplied to the vessel, a significant portion and sometimes even any residual portion of the luminal endothelial layer is demolished and flushed away.

The above illustrates that the inner wall of vascular implants of biological vessels, i.e. the intima (=Tunica intima) and its luminal endothelial tissue is strongly damaged by this common treatment in surgical practice.

The inventors of the present invention have found that the luminal endothelial tissue is of greatest importance with respect to the acute maintenance of vascular function (avoidance of thromboembolitic reactions for the purpose of a uninterrupted flow of fluid) and that the lumen of the vessel is maintained in open form for a long period (for avoidance of arteriosclerotic stenosis and subsequent thromboembolism).

A destruction of the endothelial layer—such as one that is caused, for example, by the above-mentioned treatment of autologous vascular implants—often causes thrombosis of the effected vessel. It is known that only a closed, healthy and therefore metabolically active coating of the endothelium by complex “anti-aggregatoric” (thrombocyte-inhibiting), “anti-coagulatoric-acting” (coagulation-inhibiting) and “pro-fibrinolytic” (fibrin-disintegrating) activities can prevent the presence of thrombotic deposits within the circulatory system of an organism.

The inventors of the present invention provide sufficient proof that proximal to the endothelial lesions, in which such anti-thrombogenic functions cannot be expressed, the vessel additionally tends to thrombosis. In the intima of any large blood vessel, subendothelial local “pericyte-like” cell networks are present expressing extremely high concentrations of the so called “tissue factor” (TF). The tissue factor (TF) is an integral membrane spanning glycoprotein which is constitutively expressed in people with this cell type. This membrane protein has a function in blood coagulation as an activator of factor VII, and, according to recent discoveries, is thus responsible for the initiation of nearly all clinically relevant processes of thromboses. A healthy, entirely dense endothelium protects the mainly in pericytes expressed tissue factor from flowing blood in the interior of the vessel in physiological manner. By protection of the tissue factor from the blood stream as achieved by an intact intermediary endothelial tissue, an acute thrombosis and the subsequent occlusion of biological vessels will be prevented. One reason for the destruction of the endothelium when using saline solution in the preparation of transplants could be that little or no energy metabolism and maintenance metabolism takes place in the endothelial tissue. This shows that a short-term (acute) opening rate of a biological vessel significantly depends from the condition of the endothelial tissue within the vessel.

It must be considered that the production of an entirely dense endothelial layer is not an unique event because this layer must be maintained continuously against high shearing forces which are caused by the blood stream. More particular, active metabolic events of the endothelial tissue play an important role. This includes, for example, permanent jointing processes, i.e. the occlusion of dense intercellular bases by specific proteins as well as continuous cell division processes which are mainly required for the coverage and repair of lesions (injuries) on the intimal surface. In these processes, the glycocalyx, a gel-like surface layer, plays an important role.

It was also recognized by the inventors of the present invention that the permanent (chronic) maintenance and the capability of regeneration of endothelial tissue are also essential for a long-term function of the vessel wall and consequently for the function of the biological vessels. An intact and dense endothelial layer is necessary for the generation and maintenance of a specific environment in the intima during control of the subendothelial cellular organizations. These cellular organizations extend below the endothelium as a thin network in order to be ready to react if an injury of the vessel wall occurs, but they do not reduce the lumen in any way. However, if the endothelium is injured or if this tissue is affected by a disease, growth factors from the plasma enter into these intima layers resulting in a massive and increasing proliferation of the subendothelial cell organizations. As a consequence, a long-term, increasing sclerotic deformation of the wall of the biological vessel, a reduction of the lumen and finally a surgically dreadful restenosis will occur. With “restenosis” is meant the recurrent occlusion of vessels or vascular implants associated with a loss of blood circulation in the affected tissue region.

From the above it becomes apparent that the commonly used and described methods for the treatment of isolated hollow organs or biological vessels in the surgical field cause a distraction or disintegration of the luminal endothelial tissue resulting in a rapid or long-term restenosis of the vessels. As a consequence, a re-surgical intervention in the affected patient is necessary who naturally also has a much worse prognosis with respect to the course of disease.

It is the object of the present invention to provide moderate methods and perfusion solutions for the treatment of isolated hollow organs or biological vessels to allow preservation, i.e. a maintenance and, optionally, also regeneration of the endothelial layer in the vessels to provide more reliable and long-term usable organs and vascular implants.

This object is solved by the invention according to the subject matter of claims 1-54.

Consequently, the invention relates to endothelium-protective perfusion solutions or incubation solutions, the use of the herein described endothelium-protective perfusion solutions and methods for a endothelium-preserving treatment of hollow organs and/or biological vessels comprising contacting of the hollow organs or vessels with an endothelium-protective perfusion solution.

### SUMMARY OF THE INVENTION

The invention relates to a method for the endothelium-preserving treatment and preservation of isolated hollow organs or biological vessels and vascular systems in which the hollow organ or the biological vessel is treated with an endothelium-protective perfusion solution (incubation solution) according to the invention.

The method for the endothelium-preserving treatment of hollow organs comprises the contacting of an isolated hollow organ with an endothelium-protective perfusion solution, wherein the endothelium-protective perfusion solution comprises at least the following constituents:
(a) physiological electrolyte solution
(b) at least 0.1% of weight of native albumin
(c) nutrient substrate;
   wherein treatment results in a preservation and/or repair of the endothelial tissue in the lumen of the hollow organ.

In a preferred embodiment, the native albumin in the endothelium-protective perfusion solution is replaced by 1-10 vol-% homologous hemolysin-free serum or autologous serum.

In a further preferred embodiment, the native albumin in the endothelium-protective perfusion solution is replaced by 2.5 vol-% homologous hemolysin-free serum or autologous serum.

In a further preferred embodiment, the native albumin in the endothelium-protective perfusion solution is replaced by 5 vol-% homologous hemolysin-free serum or autologous serum.

In a further preferred embodiment, the native albumin in the endothelium-protective perfusion solution is replaced by 10 vol-% homologous hemolysin-free serum or autologous serum.

In a preferred embodiment, the native albumin in the endothelium-protective perfusion solution is replaced by a homologous anti-coagulatory blood plasma preparation, comprising human plasma proteins, anti-coagulatory-acting factors and immunoglobulins wherein the pro-coagulatory-acting factors, isoagglutinin and unstable components of the blood plasma are removed.

In a further preferred embodiment, the anti-coagulatory blood plasma preparation contains sodium ions, potassium ions, calcium ions, magnesium ions, chloride ions, human serum proteins, albumin and immunoglobulins.

In a further preferred embodiment, the anti-coagulatory blood plasma preparation has the following composition: about 100-170 mM sodium ions, about 1-15 mM potassium ions, about 1-6 mM calcium ions, about 0.1-4 mM magnesium ions, about 50-200 mM chloride ions, human serum proteins, including about 25-45 g/l albumin, 3-15 g/l IgG, 1-10 g/l IgA and 0.2-3 g/l IgM immunoglobulins, pH of about 7.3 to about 7.8, and an osmolarity of about 200-350 mosmol/kg.

In a further preferred embodiment, the nutrient substrate in the endothelium-protective perfusion solution is L-glutamine.

In a further preferred embodiment, the concentration of L-glutamine in the endothelium-protective perfusion solution is between 0.5 to 10 mM, preferably 2.5 mM.

In a further preferred embodiment, the concentration of L-glutamine in the endothelium-protective perfusion solution is 5 mM.

In a further preferred embodiment, the concentration of L-glutamine is 7.5 mM.

In a further preferred embodiment, the physiological electrolyte solution comprises the following constituents: 100-150 mM NaCl; 1-15 mM KCl; 0.1-4 mM MgSO₄; 0.5-2 mM KH₂PO₄; 24-48 mM histidin-Cl and 1-3 mM CaCl₂.

In a further preferred embodiment, the physiological electrolyte solution contains energy substrates, preferably 2-10 mM glucose and/or 1-10 mM pyruvate.

In a further preferred embodiment, the physiological electrolyte solution contains 0.1-0.6 U/ml heparin and/or 50-100 μM of each uric acid and/or ascorbate.

In a further preferred embodiment, the pH value in the physiological electrolyte solution is 7.4+/−0.04 under atmospheric conditions.

In a preferred embodiment, the endothelium-protective perfusion solution additionally contains antibiotics.

In a preferred embodiment, the antibiotics are 50-400 U/ml penicillin and/or 0.1-0.4 mg/ml streptomycin.

In a further aspect of the present invention, the endothelium-protective perfusion solution is a blood plasma preparation which is free of coagulatory factors and isoagglutinins.

In a further preferred embodiment, the blood plasma preparation comprises the following constituents: 100-170 mM sodium ions, 1-15 mM potassium ions, 1-6 mM calcium ions, 0.1-4 mM magnesium ions, 50-200 mM chloride ions.

In a further preferred embodiment, the blood plasma preparation was treated with β-propiolactone and UV-radiation for virus inactivation.

In a further preferred embodiment, the perfusion solution contains one or more endothelium-promoting growth factors.

In a further preferred embodiment, the growth factor is selected from the group consisting of epidermal growth factor (EGF), fibroblast growth factor (FGF), vascular endothelial growth factor (VEGF) and stem cell factor (SCF).

In a further preferred embodiment, the perfusion solution contains flavonoides such as quercetin or rutosides, such as trihydroxyethyl rutoside or derivatives thereof.

In a further preferred embodiment, the perfusion solution contains vasodilatoric substances such as papaverin, adenosine or cardioplegic concentrations of KCl.

In a further preferred embodiment, the hollow organ is heart, intestine, uterus, kidney, bladder, lung, liver, spleen.

In a further preferred embodiment, the hollow organ is a biological vessel or vascular system.

In a further preferred embodiment, the biological vessels are blood vessels or lymphatic vessels.

In a further preferred embodiment, the endothelium-protective perfusion liquid is directed through the hollow organ by using the apparatus of the invention.

The present invention further relates to an endothelium-protective perfusion solution which comprises at least the following constituents:
(a) physiological electrolyte solution
(b) at least 0.1% of weight native albumin
(c) 0.5 to 10 mM L-glutamine

In a preferred embodiment, the native albumin is replaced by 1-10 vol-% homologous hemolysin-free serum or autologous serum.

In a preferred embodiment, the native albumin is replaced by 2.5 vol-% homologous hemolysin-free serum or autologous serum.

In a preferred embodiment, the native albumin is replaced by 5 vol-% homologous hemolysin-free serum or autologous serum.

In a preferred embodiment, the native albumin is replaced by 10 vol-% homologous hemolysin-free serum or autologous serum.

In a further preferred embodiment, the concentration of L-glutamine is 2.5 mM.

In a further preferred embodiment, the concentration of L-glutamine is 5 mM.

In a further preferred embodiment, the concentration of L-glutamine is 7.5 mM.

In a further preferred embodiment, the physiological electrolyte solution comprises the following constituents: 100-150 mM NaCl; 1-15 mM KCl; 0.1-4 mM MgSO₄; 0.5-2 mM KH₂PO₄; 24-48 mM histidin-Cl and 1-3 mM CaCl₂.

In a further preferred embodiment, the physiological electrolyte solution contains energy substrates, preferably 2-10 mM glucose and/or 1-10 mM pyruvate.

In a further preferred embodiment, the physiological electrolyte solution contains 0.1-0.6 U/ml heparin and/or 50-100 μM of each uric acid and/or ascorbate.

In a further preferred embodiment, the pH value in the physiological electrolyte solution is 7.4+/−0.04 under atmospheric conditions.

In a preferred embodiment, the endothelium-protective perfusion solution additionally contains antibiotics.

In a preferred embodiment, the antibiotics are 50-400 U/ml penicillin and/or 0.1-0.4 mg/ml streptomycin.

In a preferred embodiment, the perfusion solution is an anti-coagulatory and non-agglutinating blood plasma preparation, comprising human plasma proteins, anti-coagulatory-acting factors and immunoglobulins wherein the pro-coagulatory-acting factors, isoagglutinin and unstable components of the blood plasma are removed.

In a preferred embodiment, the anti-coagulatory blood plasma preparation comprises sodium ions, potassium ions, calcium ions, magnesium ions, chloride ions, human serum proteins, albumin and immunoglobulins.

In a further preferred embodiment, the anti-coagulatory blood plasma preparation has the following composition: about 100-170 mM sodium ions, about 1-15 mM potassium ions, about 1-6 mM calcium ions, about 0.1-4 mM magnesium ions, about 50-200 mM chloride ions, human serum proteins, including about 25-45 g/l albumin, 3-15 g/l IgG, 1-10 g/l IgA and 0.2-3 g/l IgM immunoglobulins, at a pH of about 7.3 to about 7.8 and an osmolarity of about 200-350 mosmol/kg.

In a further preferred embodiment, the blood plasma preparation was treated with β-propiolactone and UV-radiation for virus inactivation.

In a further preferred embodiment, the perfusion solution contains endothelium-promoting growth factors.

In a further preferred embodiment, the growth factors are selected from the group consisting of epidermal growth factor (EGF), fibroblast growth factor (FGF), vascular endothelial growth factor (VEGF) and stem cell factor (SCF).

In a further preferred embodiment, the perfusion solution contains flavonoides such as quercetin or rutosides, such as trihydroxyethyl rutoside or derivatives thereof.

In a further preferred embodiment, the perfusion solution contains vasodilatoric substances such as papaverin, adenosine or cardioplegic concentrations of KCl.

The invention further relates to an apparatus for endothelium-preserving treatment of isolated biological vessels comprising a chamber (1), an axially moveable stamp (6), a cannula (5), a reservoir container (7) which contains the endothelium-preserving perfusion liquid and a sealing device (3), wherein the cannula is connected with the axially moveable stamp (6) such that the cannula can be moved together with the stamp into the chamber and wherein the sealing device (3) can clasp one end of the vessel and the cannula is connected with the other end of the vessel such that the endothelium-protective perfusion solution can be selectively directed into the biological vessel, preferably by means of a pressure gradient from the reservoir container (7).

In a further preferred embodiment, the sealing device comprises sealing rings which are arranged as stacks in a knurled thumb screw.

In a further preferred embodiment, the sealing rings have a diameter of 1-10 mm and/or a thickness of 0.3-3 mm.

In a further preferred embodiment, the apparatus additionally contains a thermostat device for heating the perfusion solution.

In a preferred embodiment, the perfusion solution used in the apparatus is one of the above-mentioned and defined solutions.

The invention also relates to the use of any of the above-mentioned endothelium-protective perfusion solutions for the preservation of isolated hollow organs or biological vessels, wherein the perfusion solution produces appropriate conditions to maintain and/or renew the endothelial tissue in the lumen of the hollow organs or biological vessels.

Further, the invention relates to the use of the endothelium-protective perfusion solution for the maintenance and/or repair of endothelial tissue in isolated hollow organs or biological vessels.

The invention also relates to the use of the endothelium-protective perfusion solution for therapy and/or prevention of vascular occlusions in isolated hollow organs or biological vessels.

The present invention further comprises combinations of compositions of the utilized perfusion solutions of the invention described herein and their embodiments. The skilled person will recognize that the composition of the endothelium-protective perfusion solution may vary dependent from the field of application and the intended use and it may contain additional constituents which are required for the maintenance of the function of the endothelial tissue.

Definitions

With the expression “endothelium” or “endothelial tissue” is meant a monolayer of cells lining biological vessels and serous cavities.

With the expression “endothelial cell” is meant fully differentiated endothelial cells that are organized in a cellular formation as well as endothelial precursor cells that are not yet fully differentiated.

With the expression “endothelium-protective perfusion solution” is meant a solution which is useful for treatment of endothelial tissue in isolated hollow organs or biological vessels, wherein the consistency of the endothelial tissue is maintained. The application of the endothelium-protective perfusion solution prevents an ablation or destruction of the endothelium. The endothelium-protective perfusion solution of the invention maintains the capability of the endothelial cells for division as well as the capability of the tissues for regeneration. The perfusion solution has the property of being capable to infiltrate into very small vessels and vascular segments.

With the expression “endothelium-protective” is meant the property that the endothelial tissue is maintained (preserved), regenerated and/or enhanced, i.e. that the endothelium maintains or assembles its tissue architecture. Any endothelium-protective measure which promotionally acts on the endothelium (endothelial tissue) is also comprised. The maintenance of the cellular organization of the endothelial tissue, the maintenance of the intercellular communication and the maintenance of cell-cell-connections are also comprised. Furthermore, also the promotion of endothelial cells to divide and the increase of the endothelial cell mass per area are comprised by said expression.

With the expression “perfusion solution” is meant a solution for the preservation of isolated hollow-organs and vessels. The perfusion solution can in synonymous manner be understood as “incubation solution”.

With the expression “physiological electrolyte solution” is meant an aqueous electrolyte solution as found in physiological manner in whole blood. The expression “physiological” is not intended to limit the utilized concentrations of the individual ions it shall be understood that also “nonphysiological” concentrations, i.e. concentrations that do not normally occur in the organism, fall within the scope of the present invention. The expression “physiological” therefore comprises isotonic (synonym for “isosmotic”) solutions which provide for an uniform osmotic pressure and a constant molecular concentration. For example, if the content of potassium or the content of KCl is increased, such as found in a cardioplegic solution, then the entire ion concentration of the solution must be adapted correspondingly, i.e. the concentration of another ion of the solution must be decreased in order to keep the solution in an isotonic state. Preferred perfusion solutions are isotonic with the blood or plasma at about 290 mosm/kg H₂O.

With the expression “contacting with” is meant the incubation, deposition, rinsing or any other treatment of the organ or vessel within the perfusion solution for a time which is sufficient for the maintenance and/or regeneration of the endothelium in the vessels.

With the expression “hollow organ” is meant, in general, inner organs and vascular systems of organs in the heart, intestine, uterus, kidney, bladder, lung, liver, spleen etc. The expression “hollow organ” also includes well-known biological vessels or vascular systems such as blood vessels (arteries and veins) and lymphatic vessels.

With the expression “biological vessel” or “vessel” is meant any autologous vessels coated with endothelium for transport of body liquid. Particularly, the expression is understood in the sense of the present invention to include blood vessels, such as arteries and veins as well as lymphatic vessels.

With the expression “blood plasma preparation” is meant a liquid portion which remains after removal of blood corpuscles of blood (by centrifugation) which has been converted to be not coagulatory and which does not contain, contrary to serum, coagulation factors.

With the expression “agglutination” is meant in the sense of the present invention the antibody-specific (agglutinin-mediated) clumping of erythrocytes.

With the expression “hemolysin-free or autologous serum” is meant a serum in which no antibodies (isoagglutinins) that could bind the red blood corpuscles of a recipient, are present. Thereby, complement activation and hence lysis (decomposition) of blood corpuscles is prevented. In an autologous serum as well as in serum that is derived from a patient, such potential health risks do not naturally occur.

With the expression “nutrient substrate” is meant an amino acid or protein which is utilized by a cell for the generation of energy in energy metabolism. In general, nutrient substrates are sugars, lipids, or amino acids that are assimilated by the cell and used for the generation of energy.

With the expression “vascular diseases” is meant diseases or pathologic conditions of blood vessels such as angiopathy, vasculitis, and in particular, stenosis of arteries and veins, angina pectoris, myocardial infarct (heart attack), apoplexia (stroke), acute hearing loss, aneurysm, arteriosclerosis, thrombosis, varicose, thrombophlebitis, claudication, smoker's leg and gangrene.

### DETAILED DESCRIPTION OF THE INVENTION

The present invention is based on the finding that the endothelial layer of biological vessels is considered to be an important factor for the maintenance of vessels—in particular following transplantation.

By the methods according to the invention and by using the perfusion solution of the invention, any of the endothelium-containing biological vessels and hollow organs can be specifically treated such that the structural function of the endothelial tissue and hence the function of the vessels or hollow organs is maintained.

The treatment of isolated hollow organs and biological vessels with the endothelium-protected perfusion solutions described below and their variations allows for the preparation of organ and vessel implants prior to their implantation in the body (e.g. animal or human) in order to provide an organ and vascular implant (prosthesis or bypass), or is suitable for the repair of lesions (i.e. injuries) of the endothelial tissue in such hollow organs or biological vessels. The specific use of an incubation solution for the treatment of isolated organs and/or vessels for the maintenance of the endothelial tissue in the lumen of such organs and/or vessels is a new approach. By the treatment of isolated hollow organs with an albumin-containing solution, the endothelium in the vessels can be preserved and even regenerated by keeping endothelial cells in cellular organization, stabilizing endothelial cells, and initiating endothelial cells for proliferation. As a consequence, the lifetime of hollow organs is increased, when the organs are used, for example, as implant in surgeries in patients.

The endothelium-protective perfusion solutions as described herein are also suitable for the use for the preservation of organs and vessels from mammalians (preservation of organs and vessels) by incubation of these organs or vessels in the perfusion solution. Such a preservation of organs or vessels is, for instance, particularly desirably for transplantation surgery. A preservation may also be required to protect and functionally maintain organs and vessels for transport. It is the aim of the method of the present invention and the used perfusion solution to ensure the function, capability and consistency of the organ and vessel by maintaining, or even regenerating, the luminal endothelial cell layer.

A functional and structurally intact endothelial tissue provides for a long lifetime of vascular implants because it is possible to prevent vascular occlusion caused, for example, by thrombosis or sclerotic restenosis.

The invention also relates to an apparatus which can be used to rinse an isolated biological vessel with the endothelium-protective perfusion solution. By means of this apparatus, biological vessels can be conveniently and efficiently be tested for their impermeability. Furthermore, all branches of the biological vessel can directly be identified and ligated by suitable ligation means such as clamps or micro-clips.

The embodiments of the endothelium-protective perfusion solutions described herein are therefore suitable for the use for the preparation of such vessels as implants for the treatment of vascular diseases. Such vascular diseases or pathological conditions are, for example, angiopathy, vasculitis, in particular stenosis of arteries and veins, angina pectoris, myocardial infarct (heart attack), apoplexia (stroke), acute hearing loss, aneurysm, arteriosclerosis, thrombosis, varicose, thrombophlebitis, claudication, smoker's leg and gangrene.

The endothelium-protective perfusion solution is also suitable for the repair of the vascular system of hollow organs and/or biological vessels or for the preservation of whole organs or vessels or portions thereof for surgeries, transplantations, storage or transport.

The hollow organs or biological vessels treated with the endothelium-protective perfusion solution of the invention reveal a non-damaged endothelium and improved perfusion capability of the vessels as compared to untreated or conventional solutions such as physiological salt solution (saline), Bretschneider solution, University of Wisconsin (UW) solution, Carolina Rinse solution and HTK solution for rinsing or incubation of hollow organs or vessels. By using the perfusion solutions according to the invention described herein, an early thrombosis (vascular occlusion) of the affected vessel is prevented or at least timely delayed.

The isolated hollow organs or biological vessels treated by the method according to the invention have the advantage over hollow organs or biological vessels that are typically used in the field of organ and vascular transplantation, that the endothelial tissue of the treated hollow organ or vessel is kept intact and can even be regenerated if the endothelial tissue is damaged (e.g. by promoting the proliferation of endothelial cells).

By treating the endothelium with a perfusion solution of the invention, also a regeneration of endothelial tissue occurs. The endothelial cells maintain their capability to divide and are capable to repair endothelial lesions of affected hollow organs or biological vessels by promoting the proliferation of endothelial cells. Untreated vessels or vessels that were treated with a conventional physiological saline solution which is commonly used in surgery practice, cause a lesion or a complete destruction of the endothelium which takes place already within the first hour following treatment.

By the method of the invention, it is further possible to keep or to store vessels that were treated with the endothelium-protective perfusion solution described herein for a longer time, i.e. for a period up to several days. This allows for a convenient handling upon storage of the vessels, a singular logistic supply during transplantation or bypass surgeries as well as a better planning of such interventions.

The endothelium-protective perfusion solution of the invention comprises in its basic composition a physiological electrolyte solution, at least 0.1% per weight albumin and one nutrient substrate such as, for example, L-glutamine (2.5-10 mM).

With these basic constituents of the perfusion solution of the invention (=basic solution), it was surprisingly found that there is an endothelium-preserving or endothelium-protective effect in isolated biological vessels (see Examples 1 and 2). As electrolyte, the physiological electrolyte solution contains at least magnesium ions (Mg²⁺), chloride ions (Cl⁻¹) and calcium ions (Ca²⁺) within a physiological range of concentration. Preferably, the physiological electrolyte solution contains one or more of the following ions: potassium ions (K⁺), sodium ions (Na⁺), sulfate ions (SO₄²⁻) and phosphate ions (PO₄³⁻). By the addition of further constituents, which are described in more detail below, the positive effect on the endothelial tissue is further enhanced. The efficiency of the endothelium-protective perfusion solution of the invention can be explained by a combination of albumin, and the salts of the electrolyte solution, in particular by the presence of calcium (Ca²⁺) and a nutrient substrate. Calcium is required for the maintenance of the function of the endothelial tissue because in the presence of Ca²⁺ the structure of its glycocalyx is maintained. This structure creates the necessary micro-environment on the endothelial surface which is important for the physiological function and activity of many endothelial enzymes, membrane transporters, ion channels and receptors.

The added amino acid glutamine (L-glutamine or D-glutamine) is used in the basic composition of the perfusion solution of the invention as nutrient substrate. It also serves for the purpose, that if glutamine is available particular endothelial cells, which permanently produce highly reactive oxygen metabolites, such as hydrogen peroxide, oxygen radicals and nitrogen monoxide can be protected by an unknown but reproducible mechanism against these oxidants.

Albumin is also a component of the perfusion solution of the invention and is inter alia for the endothelium-preserving effect of the solution. For example, albumin reduces the “shearing forces” and the surface tension occurring on the surface of the endothelium when rinsing (blood) vessels, which otherwise would rather facilitate and result in a spherical formation but not spreading of the endothelial cells. Both physical measures (forces) are responsible for a likely ablation of endothelial cells. Albumin therefore acts somehow in the vessel similar to a “lubricant” in machines. The “crystalloid” (=protein-free) rinsing solutions as used by the surgeons, such as physiological saline solution or cardioplegic “Bretschneider solution” (because of its rich potassium content), cannot reduce these high shearing forces and surface tension in the required dimension.

A combination of nutrient substrate (e.g. glutamine) and albumin for the purpose for maintaining the endothelium is required in minimum because a prolonged exposure of the endothelium to shearing forces in albumin-free solution requires a higher energy alteration and energy demand of the endothelium because additional energy must be supplied in order to allow endothelial cells adhering to the vascular wall.

Further advanced studies with the method according to the invention show that plasma derivatives which do not contain coagulation factors and agglutination factors, such as agglutinins (e.g. agglutinating antibodies, hemagglutinins, lectines, hemolysin, phythemagglutinins), complement factors, inflammation mediators or blood type-specific antibodies, are particularly preferred for the treatment of isolated hollow organs or biological vessels. The absence of such factors in a perfusion solution could result in undesired reactions with and on the surface of endothelial cells of the vessels. It is possible that, for example, the attachment of antibodies to antigens on the surface of endothelial cells mediated lysis of these cells, wherein this could result in a complement. The formation of immunocomplexes under complement activation can also result in thrombosis. As a consequence thereof, this could result in a narrowing or vascular occlusion of the treated vessel with the consequence, that, for example, vascular or organ implants once again need to be replaced. Therefore, serum preparations or solutions are particularly preferred because they are substantially free from coagulation factors which could initiate the blood clotting cascade.

In addition, blood plasma preparations are useful, and particularly preferred, as endothelium-protective perfusion solutions for the preparation of the endothelium by the endothelium-protective method of the invention or for the uses of the invention, respectively. Many specific proteins of the normal blood plasma exhibit particular additional functions which can be beneficial for endothelial functions: transferrin and ceruloplasmin act, for example, as transport proteins for iron or cupper ions, respectively, and hormone transport proteins are beneficial for substantial enzyme functions in the endothelium or signal transduction processes in endothelial cells. Furthermore, growth factor hormones are important components which are beneficial for cell division, a requirement for repair, and coating of endothelium-damaged vascular walls.

Such blood plasma preparations exhibit, in contrast to the above-mentioned basic solution and its preferred embodiments, an increased endothelium-preserving effect, which most likely is due to additional factors that are present in the blood plasma, such as, for example, growth factors which are beneficial for the maintenance of the endothelial tissues in the lumen of the vessels. Blood plasma naturally consists of approximately 90% of water, about 8% of proteins, such as albumin (about 40 g/l), globulin (α1-globulin, α2-globulin, β-globulin, γ-globulin), transport vehicles such as hormones and bilirubin as well as coagulation factors.

In the methods and uses according to the invention, those blood plasma preparations are preferred in which the above-mentioned factors, such as coagulation factors, agglutination factors, such as agglutinins, complement factors, inflammation mediators or blood type-specific antibodies are not present anymore, and which are free of toxic lipids and germs, such as viruses and bacteria.

In the basic composition of the perfusion solution, the electrolyte solution which is preferably used is one corresponding to a electrolyte solution comprising physiological inorganic salt constituents of the healthy human blood plasma. In a possible embodiment of the invention, the bicarbonate constituent of the common electrolyte solution is replaced by equimolar histidin chloride.

The electrolyte solution according to the invention comprises the following composition: 100-150 mM NaCl; 1-15 mM KCl; 0.1-4 mM MgSO₄; 0.5-2 mM KH₂PO₄; 24-48 mM histidin-Cl and 1-3 mM CaCl₂. A preferred composition of the electrolyte solution comprises: 140 mM NaCl; 4.5 mM KCl; 1.2 mM MgSO₄; 1.2 mM KH₂PO₄; 24 mM histidin-Cl; 2.5 mM CaCl₂. Histidin-Cl can also be replaced by 24 mM bicarbonate. The calcium concentration in the solution can be lowered in isotonic manner to a value of 0.01-0.1 mM.

In atmospheric environment, the pH value of the electrolyte solution is 7.2 to 7.8, and is preferably adapted to the normal value of arterial blood (pH=7.4+/−0.04). The adjustment of the pH is achieved by the addition of CaCl₂ which is added as last component of the solution. The adjustment of the pH can be achieved, for example, by a buffer which contains one or more acids and/or bases. Examples of such buffer substances are lactate and/or bicarbonate.

For energy maintenance of the endothelial metabolism, the perfusion solution of the invention contains energy substrates, preferably 2-10 mM glucose and/or 1-10 mM pyruvate. These energy substrates themselves allow for a sufficient provision of energy for the metabolism of the endothelial tissue, even under nearly hypoxic conditions (pO₂≦10 mm Hg). Preferred concentrations of energy substrates are 8 mM glucose and/or 2 mM pyruvate. The physiological electrolyte solution contains, in a further embodiment of the perfusion solution of the invention, heparin or other anti-coagulatory agents, such as heparin, heparinoids, cumarin (vitamin K-antagonist), in anti-coagulatory concentrations. Usual anti-coagulatory concentrations for high molecular heparin are 0.2-0.6 U/ml, preferably 0.4 U/ml when using human blood. In a further embodiment of the invention, no molecular heparin is used, such as the heparin supplied by Pharmacia Ltd. at 100 μl/100 ml. In addition, 50-100 μM of each of uric acid and/or ascorbate can be added as exogenous reduction agent(s) as anti-oxidants against escharotic oxygen compounds.

A concentration of already 0.1% per weight of native albumin results in a significant stabilization of the endothelial tissue. “Native albumin” means that the albumin is present in its natural (native) form and is preferably purified by chromatographic methods and not by the application of heat. Human albumin is preferred. The effect of albumin on the stabilization of the endothelial tissue can be determined experimentally by using microscopy in phase contrast and by time lapse cinematography (see Example 2). In this regard, native albumin has been proven to be advantageous as compared to heat-treated albumin. Natural albumin can be present, for example, in a concentration range of 10-50 g/l, preferably 30-45 μl and most preferred at about 40 g/l.

The density of the endothelial layer can be quantitatively measured by determination of the hydraulic conductivity (Lp [cm/s/cm H₂O]). In comparison to endothelial layers treated by the perfusion solution of the invention, the endothelial layers that were treated in saline or in Bretschneider solution lose their density because the individual cells detach as spheroids from the surface.

A further embodiment of the endothelium-protective perfusion solution of the invention contains homologous hemolysin-free or autologous serum instead of albumin. In this case, no additional native albumin needs to be added because it is already present in the serum.

A decreasing stabilization of the native density of the endothelial cells over several days can be effected if hemolysin-free serum or autologous serum is added to the electrolyte solution. The serum is preferably free from lipoprotein. In accordance with the perfusion solution of the invention an non-diluted autologous serum has a albumin concentration of at least 6% per weight taking over the function of native albumin even at higher dilution. In addition, human serum contains a plurality of growth factors in effective concentrations (e.g. >0.1 ng/ml each of bFGF, TGF, VEGF). A concentration of 1-10 vol-% homologous hemolysin-free serum or autologous serum is added to the endothelium-protective perfusion solution. Preferably, the serum concentration is 5-10 vol-%. At a concentration of already 1 vol-%, autologous or homologous hemolysin-free serum results in remarkably improvement in stabilization of endothelial density. Particular embodiments of the invention have a serum concentration of 2.5 vol-%, 5 vol-% or 10 vol-% (vol-%=portion of serum protein/l solution).

In different embodiments of the invention the L-glutamine contained in the endothelium-protective perfusion solution can have a concentration of 2.5 mM, 5 mM or 7.5 mM wherein a concentration of 2.5 mM L-glutamine is preferred.

In a further embodiment of the invention, the endothelium-protective perfusion solution additionally contains antibiotics at bactericidal concentrations. For example, 100-400 U/ml penicillin and/or 0.1-0.4 mg/ml streptomycin are preferred, wherein 200 U/ml penicillin and 0.2 mg/ml streptomycin are most preferred.

A preferred perfusion solution which can be utilized for endothelial preservation and endothelial regeneration has the following composition: physiological (isotonic) electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 prior to addition of CaCl₂); 0.1% albumin and 2.5 mM L-glutamine, 2 mM Na-pyruvate, 8 mM glucose, 200 U/ml penicillin and 0.2 mg/ml streptomycin, low molecular heparin (fraxiparin obtained from Pharmacia Ltd.: 100 μl/100 ml complete solution) and, in addition, 50 μM of each of uric acid and ascorbate.

A further very effective solution that has been tested in the examples to be useful in the methods or uses of the invention has the following composition: 127 mM NaCl; 4.6 mM KCl; 1.1 mM MgSO₄; 1.2 mM KH₂PO₄; 24 mM histidin-Cl; 2 mM CaCl₂; 10 vol-% lipoprotein-free, hemolysin-free, homologous serum preparation from a pool of blood preparations, 2.5 mM L-glutamine, 2 mM Na-pyruvate, 8 mM glucose, 200 U/ml penicillin and 0.2 mg/ml streptomycin, low molecular heparin (fraxiparin obtained from Pharmacia Ltd.: 100 μl/100 ml complete solution) and in addition 50 μM of each of uric acid and ascorbate.

Besides, an effective amount of one or more flavonoid compounds (or derivatives thereof) can be added to the perfusion solution of the invention to avoid microcirculatory complications (e.g. endothelial lesions) caused by releasing products of simultaneously activated granulocytes or thrombocytes in the vessel lumen. Preferred flavonoids that were tested in effective concentrations in the methods according to the invention are quercetin (about 50-250 μM) and rutoside compounds, in particular, trihydroxyethyl rutoside (about 50-250 μM).

A particularly preferred embodiment for endothelial maintenance and regeneration of the endothelial layer at microcirculatory complications has the following composition: isotonic electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 prior to addition of CaCl₂); 0.1% albumin and 2.5 mM L-glutamine, 2 mM Na-pyruvate, 8 mM glucose, 200 U/ml penicillin and 0.2 mg/ml streptomycin, low molecular heparin (fraxiparin obtained from Pharmacia Ltd.: 100 μl/100 ml complete solution) und additionally 100 μM freshly added quercetin. Instead of quercetin, 100 μM trihydroxyethyl rutoside can also be added.

In surgical practice, it would also be desirable to prevent, or at least, to reduce the formation of spasms of the vessels. This can also be effected by the addition of effective amounts of vasodilators such as papaverin or adenosine. Papaverin is preferred at 50-200 μM. A concentration of 100 μM papaverin is particularly preferred. Adenosine is preferably added at a concentration of 0.5 to 2 mM, wherein 1 mM is particularly preferred.

A particularly preferred solution that is utilized in the methods and uses of the invention has the following composition: 127 mM NaCl; 4.6 mM KCl; 1.1 mM MgSO₄; 1.2 mM KH₂PO₄; 24 mM histidin-Cl; 2 mM CaCl₂ (pH to 7.40 prior to addition of CaCl₂); 0.1% albumin and 2.5 mM L-glutamine, 2 mM Na-pyruvate, 8 mM glucose, 200 U/ml penicillin and 0.2 mg/ml streptomycin, low molecular heparin (fraxiparin obtained from Pharmacia Ltd.: 100 μl/100 ml complete solution) and in addition 100 μM papaverin (or 1 mM adenosine).

In particular in cardiac surgical practice, e.g. heart transplantations, it would be desirable to stabilize the heart during extraction and incubation in the perfusion solution of the invention such that the contractions of the heart will stop. This can be achieved by increased potassium concentration in the perfusion solution. Such a solution is also called a “cardioplegic solution” because it inhibits the electric activity of the heart, and, as consequence, its contraction. It should be ensured that the cardioplegic solutions are preferably isotonic, i.e. they should have the same molecular concentrations in order to avoid damages of the vascular walls or the functionality of the organ. Even at a concentration of potassium of more than 6 mM, there is a decline in the contraction of the heart. At a concentration of 8 mM, there is nearly a complete paralysis of the heart. This stabilization of the organ allows for a convenient handling during transplantation by the surgeon.

The complete solution can be stored at a temperature of 4° C. in darkness for several months without losing its efficiency. A sterilization for avoidance germs in the solution can be carried out, for example, by using sterile filters.

In a further embodiment, a blood plasma preparation can be used in the endothelium-protective methods of the invention for the treatment of isolated hollow organs and biological vessels. It was surprisingly found by the inventors, that the inhibitory and modulating properties associated with such a serum-like solution (blood plasma preparation) is beneficial for the integrity of endothelial cells. In comparison to the basic composition of the endothelium-protective perfusion solution, containing a physiological electrolyte solution, a nutrient substrate and albumin, and which already exhibits a substantial maintenance of the endothelium (see examples), the efficiency for preservation and maintenance of the endothelium in hollow organs can be further increased by using a homologous anti-coagulatory blood plasma preparation rather than albumin. Therefore, a perfusion solution in which the native albumin in the basic composition of the endothelium-protective perfusion solution is replaced by a anti-coagulatory blood plasma preparation, comprising human plasma proteins, anti-coagulatory factors and immunoglobulins, and in which the pro-coagulatory-acting factors, isoagglutinins and unstable components of the blood plasma are removed, is preferred. Such unstable factors are, e.g. lipoproteins and other toxic lipids.

The use of heparinized (i.e. heparin-treated) blood plasma is preferred due to the maintenance of the physiological concentration of calcium.

With a “blood plasma preparation” is meant a blood plasma solution prepared from isolated whole blood constituting an isotonic 5 vol-% solution of human serum proteins. Whole blood is preferably derived from blood obtained of mammalians, in particular human whole blood from healthy donors (e.g. a pool of 1000 healthy donors). A blood plasma preparation contains, in addition to water (about 90%), inorganic electrolytes (e.g. sodium, potassium, calcium, magnesium, chloride ions) nutrient substrates, such as amino acids, sugars and fatty acids, and native albumin is therefore useful in the sense of the present invention. In addition, the plasma contains many important transport proteins (e.g. transferrin, ceruloplasmin, etc.). Such a blood plasma preparation is preferably a non-agglutinating and anti-coagulatory blood plasma preparation in which the coagulation of blood is inhibited by addition of substances that inhibit blood coagulation or in which no or only little coagulation factors are present. Such anti-coagulating-effective substances are, for example, anti-thrombin III, together with heparin and heparinoids. Blood plasma preparations that are free from oxalic acid, EDTA or citrate and Ca ions for the use in the maintenance of the endothelium in isolated organs or vessels are also comprised in the sense of the invention.

In the method of the invention in which isolated hollow organs and biological vessels are treated with the endothelium-protective perfusion solution for transplantation purposes also those blood plasma preparations are preferred in which unstable components such as toxic lipids or lipoprotein as well as factors that cause immunoreactions (e.g. blood type-specific antibodies) and germs, such as viruses and bacteria, are removed by appropriate measures that are well-known in the art.

A common blood plasma preparation that is used in the invention preferably comprises the following ionic constituents:

About 100-170 mM sodium ions, about 1-15 mM potassium ions, about 1-6 mM calcium ions, about 0.1-4 mM magnesium ions, about 50-200 mM chloride ions. More preferred are about 150 mM sodium ions, about 4 mM potassium ions, about 2 mM calcium ions, about 1 mM magnesium ions, about 110 mM chloride ions.

Further, the blood plasma preparation comprises native albumin, e.g. in concentration ranges between about 25-45 g/l, preferably about 30-40 g/l, most preferred about 32 g/l.

In addition, the blood plasma preparation commonly contains immunoglobulins, wherein the content of immunoglobulin G can be about 3-15 g/l, IgA 1-10 g/l and IgM about 0.2-3 g/l. Preferably, the blood plasma preparation contains about 7 g/l IgG, 1.7 g/l IgA and about 0.5 g/l IgM.

The pH value of the blood plasma preparation equals about 7.3-7.8 and is preferably 7.4. Preferably, the blood plasma preparation has a osmolarity of 200-350 mosmol/kg, more preferably about 288 mosmol/kg.

A particularly preferred embodiment of the blood plasma preparation of the invention comprises the following composition: 150 mM sodium ions, 3.65 mM potassium ions, 1.97 mM calcium ions, 1 mM magnesium ions, 107 mM chloride ions, 32 g/l albumin, immunoglobulins IgG 7 g/l, IgA 1.7 g/l, and IgM 0.5 g/l and 51 g/l total protein, and nutrient and energy donors that are naturally present in blood plasma.

A particularly preferred embodiment of the blood plasma preparation is an isotonic 5% solution of human serum proteins, produced from the plasma of healthy donors.

The preparation contains complete and biologically intact immunoglobulins in stable form, albumin and transport and inhibitor proteins in natural concentration ratios. In order to ensure a good storage stability, the preparation is preferably free of lipoproteins, free of hemolysin and free of coagulation factors. A preferred embodiment of such a preparation comprises the following composition: about 3.65 g/l sodium ions, 0.16 g/l potassium ions, 0.08 g/l calcium ions, 0.02 g/1 magnesium ions, 3.65 μl chloride ions, 50 g/l human serum proteins, including about 31 g/l albumin, about 10 g/l immunoglobulins of human with IgG present at about 7.1 g/l, IgA about 1.55 g/l, and IgM about 0.48 g/l and water. The titer of isoagglutinins of the solution (anti-A and anti-B) is preferably <=1:64.

For the method of the invention and the uses of the invention, the blood plasma preparation is used as perfusion solution which is free of pyrogens and which was treated by virus- and/or bacteria-inactivating measures (treatment with 5-propiolactone and UV-radiation, heating to 37° C.).

It is preferred that the blood plasma solution does not contain any anti-complementary, anti-coagulatory or agglutinating activity.

The use of an anti-coagulatory blood plasma preparation rather than adding albumins to the basic composition of the perfusion solution of the invention shows a remarkable endothelium-preserving efficiency, which is even increased in comparison to the basic composition. This is most likely due to serum proteins present in the plasma, which inter alia play an important role in the transport of compounds.

In the following, a preferred method for the preparation of an endothelium-preserving perfusion solution on the basis of a blood plasma preparation is described:

The method comprises the provision of blood plasma (e.g. from a mammal such as horse or cattle, preferably human). The human blood plasma can be derived from several different donors and is collected as mixed preparation (pool of plasma). The cryoprecipitate is preferably separated from liquid blood plasma constituents by using centrifugation at a temperature of about 5° C. As one step of virus inactivation the remaining blood plasma is treated with β-propiolactone, i.e. β-propiolactone is added in liquid form to the blood plasma pool. For further virus inactivation, the plasma treated with β-propiolactone is treated with ultraviolet radiation using an UV exposure apparatus. Subsequently, coagulatory-active (i.e. coagulatory) proteins are separated by anion exchange chromatography, e.g. by using a DEAE Sephadex column. In addition, a deep bed filtration and sterile filtration can be performed which allows for storage of the solution of plasma proteins over an extended period of time (more than 21 days) at a temperature of 22° C. A subsequent treatment with Aerosil® effects the adsorption of storage-stable proteins and lipids. This treatment also results in a removal of possibly present viruses. A diafiltration and ultrafiltration is followed which allows for the adjustment of the protein solution. At this step, the adjustment of the pH value and sterile filtration is performed which allows for storage of the intermediate product for about 30 days at a temperature of 37° C. Several intermediate products of this step can be combined with each other (“pooled”) in order to arrive at the final blood plasma preparation. This blood plasma preparation is free of pyrogens and free of viruses and can be used in the method for endothelium-preserving treatment of isolated hollow organs or biological vessels of the invention or for the above mentioned uses, i.e. for the treatment or preservation of organs or vessels for the preparation as organ or vessel implants or for the repair of injuries of the endothelial tissue.

The skilled person will recognize that perfusion solutions or incubation solutions can be used in the above-mentioned methods and uses in modified form. For example, the perfusion solution can differ in their salt and protein composition. Also solutions which contain naturally occurring or artificially added amino acids, lipids, carbohydrates, nucleic acids (RNA, DNA), peptides such as, e.g., gelatine preparations, hormones and plant materials, e.g. dextrans, liposomes for transfer of lipophilic active ingredients, hormones or nutrients, to enhance or specify the effect of the perfusion solution can be used in the methods or the above-mentioned uses of perfusion solutions of the invention, as long as they contain the above-mentioned basic constituents which are responsible for the endothelium-preserving effect.

Modified solution of the perfusion solutions of the invention may also contain growth factors or other proliferation-promoting substances in effective concentrations which are useful for the maintenance and/or proliferation of the endothelial tissue in that they promote the division of endothelial cells or maintenance of tissue organization of endothelial cells. As shown in the examples, growth factors or growth hormones (such as e.g. hydrocortisone or equivalent factors) also reduce the division time for cell division which is beneficial for a rapid regeneration of the endothelial layer. The regeneration of the endothelium or the initiation of division of endothelial cells in a damaged endothelial tissue (lesions) of a biological vessel or hollow organ is therefore one field of application in which growth factors or hormones can be utilized in the endothelium-protective solution. Examples of such growth factors are epidermal growth factor (EGF), vascular endothelial growth factors (e.g. VEGF1, VEGF, VEGF3), fibroblast growth factor (FGF) and stem cell factor (SCF) or equally acting factors. Further growth factors which can be utilized comprise VEGF121, VEGF165, VEGF189, bFGF, P1GF, PDGF, GM-CSF and G-CSF.

Such growth factors promote the specific maintenance or proliferation of endothelial tissue in vessels by binding to specific surface receptors of this tissue in order to initiate signal transduction mechanisms that result in the expression of growth promoting genes or gene groups. On the other hand, the gene products can effect division of endothelial cells involving complicated interactions.

A preferred solution that contains growth factors of the invention has the following composition:

Isotonic electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 before addition of CaCl₂); 0.1% albumin and 2.5 mM L-glutamine, 2 mM Na-pyruvate, 8 mM glucose, 200 U/ml penicillin and 0.2 mg/ml streptomycin, low molecular heparin (fraxiparin from Pharmacia Ltd.: 100 μl/100 ml complete solution), 0.1-1 ng/ml epidermal growth factor (EGF), 0.2-2 ng/ml basic fibroblast growth factor (bFGF) and hydrocortisone 0.2-3 μg/ml.

The skilled person will recognize that these and other modifications can increase the endothelium-preserving effect of the perfusion solution on the endothelium of the vessels. For example; this can comprise factors that maintain or modify the glycocalyx of the endothelial cells (i.e. a proteoglycan and glycoprotein-rich, gel-like layer, which is coupled to surface proteins and phospholipids in the outer portion of the cell membrane) such that the tissue architecture or tissue structure of the cellular organization in the cellular spaces remains intact or is even improved. Also, the addition of one or more cytokines (e.g. TNF, TGF, IFN) or active plant ingredients, such as berberin (isolated from Berberis airstata) to the perfusion solution may be useful in order to maintain or regenerate the endothelial cell layer for preventing or avoiding an early thrombosis.

Further, endothelial cell-specific factors can be added that stimulate the expression of genes, encoding for cell surface receptors. Examples of such receptors are CD34, CD133, KDR (VEGFR-2), VE-cadherin, E-selectin, αᵥβ₃, endothelial precursor cell-specific lectines or other receptors, which are specific for endothelial cells and/or precursor receptors.

The skilled person will also recognize that such compounds or factors can be added to the basic solution of the endothelium-protective perfusion solution which promote the propagation and dispersion of endothelial cells or endothelial precursor cells. Such substances are, for example, fibrin, fibronectin, laminin, gelatine or collagen for the promotion of cell wall-specific anchoring of endothelial cells, or purine and pyrimidine compounds such as adenosine, inosine, hypoxanthin or thymidine, uridine and cytosine for the promotion of the energy metabolism and nucleic acid metabolism as well as signal transmission of endothelial cells.

Also, particular drugs and food additives may promote the endothelial functions and concentration of the endothelium. As shown in the examples, a great number of flavonoid compounds, e.g. quercetin, rutoside compounds or their glycosides (e.g. quercetin-glucuronate) promote the compactness of inter-endothelial cell spaces by strongly relaxing the contraction apparatus of endothelial cells. Antioxidantive substances such as uric acid, vitamin E or flavonoids protect the endothelium against the influence of oxidants. Vasodilative active ingredients such as adenosine or papaverin may relax the smooth skeletal muscles and prevent spasms which may, under certain conditions, also damage the tissue by extreme folding of the endothelium. In this regard, the skeletal muscles of bypass vessels are relaxed and spasms of vessels are prevented, which otherwise could only be overcome by the application of high intravascular extension pressures with the consequence of massive endothelial lesions.

Modifications of the endothelium-preserving perfusion solution of the invention include fresh frozen plasma. This essentially corresponds to human blood plasma which was shock frozen at or below −18° C. within few hours. The fresh frozen plasma contains plasma protein (such as the required albumin), coagulating factors, von Willebrand's factor and colloids. The fresh frozen plasma does not contain erythrocytes, leucocytes and thrombocytes.

In order to prevent or preclude an early thrombosis of the vessel, anti-coagulation of the fresh frozen plasma should be avoided (e.g. by addition of anti-coagulants such as heparin, citrate, EDTA, etc.).

Attention should be drawn that the perfusion solution does not contain any isoagglutinins, complement factors and coagulation factors which may result in a damage of the vascular endothelium if the blood types between donor and acceptor endothelium is not identical. It should be considered that endothelial cells exhibit the same blood type features as erythrocytes and therefore are capable to react against foreign plasma via isoagglutinins (=antibodies which are directed against blood types).

Further modifications of the perfusion solution of the invention include, for example, plasma expander solutions (gelatine- or dextran-containing) or modified human albumin preparations which may be additionally enriched with nutrient substrates and energy substrates.

In this regard, it should be expressively emphasized that the invention comprises any combination of the herein described components and additives of the solution. The invention shall not be restricted to a particular embodiment. The person skilled in the art will recognize that the combination of individual components with their individual effects is possible to achieve endothelial maintenance and preservation of vessels and organs. The skilled person will select the further components of the perfusion solution and their concentrations in dependency of the use and type of the hollow organ, wherein the basic components, physiological or isotonic electrolyte solution, nutrient substrate and, in particular, albumin are contained in all solutions described herein. The skilled person will also recognize that the components described herein may be replaced by equally-acting factors or substances in order to achieve the desired effect (e.g. equally-acting growth factors to EGF or bFGF).

The skilled person will also recognize that combinations of the solutions described herein are comprised as modifications of the used perfusion solution of the invention.

According to FIG. 1, the apparatus for endothelium-preserving treatment of isolated biological vessels of the invention comprises a chamber (1), an axially moveable stamp (6), a cannula (5), a reservoir container (7) which contains endothelium-preserving perfusion liquid and a sealing device (3), wherein the cannula is connected with the axially moveable stamp (6) such that the stamp can be moved into the chamber and wherein the sealing device (3) can clasp one end of the biological vessel and the cannula can be connected with the other end of the vessel such that the endothelium-protective perfusion solution can be selectively directed from the reservoir container (7), preferably by means of a pressure gradient, into the biological vessel.

In a preferred embodiment of the apparatus of the invention, the sealing device comprises deformable sealing discs which are arranged below a knurled thumb screw as stacks.

Preferably, the stacked sealing discs in the knurled thumb screw are compressible and are separated by perforated intermediate discs, for example by discs of steel. It is preferred that the discs of steel have a thickness of 0.5-2 mm. The stacked sealing discs are spaced from the perforated discs of steel. Preferably, the diameter of the openings of the intermediate discs are 1-2 mm smaller than the diameter of the corresponding selected sealing discs.

Preferably, the sealing discs have a diameter which is adapted to the size of the vessel to be sealed. In this regard, the diameter of the vessel is larger than the diameter of the sealing discs, so that the vessels are tightly clasped by the sealing discs in an area of the sealing discs where the vessel is to be inserted, whereby the lumen of the vessels that are filled under pressure and thereby expended, will not be constricted.

The diameter of the sealing discs can be adapted to the outer diameter of the vessel by compressing the deformable sealing discs. In case of blood vessels, the diameter of the sealing discs is preferably 1-10 mm and/or have a thickness of 0.3-3 mm. With respect to hollow organs, the vessels correspond to the feeding arteries or the leaving veins of the organ vascular system of the corresponding hollow organ. Preferred material of the sealing discs is silicon or any other material that is useful and deformable for sealing. The perforated discs of steel preferably consist of steel, for example V2A steel.

A preferred embodiment of the apparatus of the invention as shown in FIG. 1 contains a chamber (1) and silicon sealing discs (3) having a central perforation, which is arranged in a knurled thumb screw. The chamber preferably has a cylindric form. By the perforation in the sealing discs, one end of a blood vessel (1) (e.g. artery or vein) is slightly inserted and a short piece is closed with a clamp. The other end of the vessel is connected with the cannula (5) of the stamp portion. The cannula is preferably connected with a flexible tube which in turn is connected with the reservoir container (7). The reservoir container contains the endothelium-protective perfusion solution of the invention and can be, for example, a Boyle Mariott's bottle.

In a preferred embodiment of the present invention, the perfusion solution is directed by means of a pressure gradient (Δp) between the reservoir container and the chamber with a defined and constant pressure from the reservoir container into the cannula and then into the blood vessel. The simplest way for generation of a natural pressure gradient is a hydrostatic difference in height which can be achieved, for example, by positioning the reservoir bottle in about 1.30 m height above the chamber. Subsequently, the axially moveable stamp (6) is tightly inserted together with the preceeding blood vessel into the inner space of the chamber.

If the endothelium-protective perfusion solution is now applied into the vessel under a mediate pressure, perfusion liquid can leak from the branches of the vessel. The spouting of liquid from the branches of the vessel in the inner space of the chamber decreases rapidly due to the increasing backpressure. By further screwing the knurled thumb screw into the sealing area, it is possible to essentially seal the inner space of the cylinder in the discharge area of the vessel such that no further leaking from branches that are located in this area takes place. If the blood vessel is now carefully moved forward further through the perforation of the sealing discs, there will be a selective spouting of perfusion solution from all newly emerging branches (8) which can be immediately ligated by ligation means (9). In this way, it is possible to perform a sealing test of biological vessels that are required for surgery, especially those that are envisaged for an arterial bypass, at a defined and constant pressure in a way that it is preservative for the endothelium. In addition, work can be carried out properly, i.e. any flooding as it occurs when using the above-mentioned saline is avoided. Finally, the vessel is fully withdrawn from the vessel and is again tested in its full length for its impermeability by applying a perfusion pressure (e.g. 250 mm Hg). Subsequently, the vessel can be stored in the protective perfusion solution until transplantation, preferably at a temperature of 37° C.

In a further embodiment, the perfusion liquid of the invention is additionally guided over a flowspirale of a thermostat system such that the perfusion liquid is preferably heated up to a temperature of 37° C.

The apparatus can additionally contain one or more breather screws which are attached with the chamber and serve for exhausting or removal of the content of the chamber.

The apparatus of the invention is also suitable for any biological vessels such as, e.g. blood vessels, arteries and veins or lymphatic vessels. With regard to the provision of vessels for a vascular transplantation or bypass operation, the utilization of the apparatus for the endothelium-preserving treatment of blood vessels is particularly preferred.

The apparatus of the invention advantageously provides a constant pressure gradient over the vessel wall which prevents collapsing of the vessel and a resulting damage of the endothelial tissue.

By means of the knurled thumb screw and the sealing discs described therein, the contact pressure on the vessel segment can be varied and the impermeability can be regulated.

The stamp preferably moves in axial direction, i.e. through the chamber into the direction to the sealing device.

Besides the above-mentioned advantages, the apparatus of the invention allows for a precise and consistent treatment of the vessel with the perfusion solution of the invention. Thus, the apparatus allows for a constant supply for the endothelial cells with perfusion liquid. This allows for replacement of biologically important metabolism molecules which are required for maintenance or proliferation of the endothelial cells.

The apparatus is also suitable for testing the impermeability of biological vessels. In this regard, the vessel segment is pulled over the sealing discs and is tested piece by piece for its impermeability. The so identified vessel leavings can then be ligated with suitable ligation means, e.g. clamps or micro clips. In the sense of the invention, also smallest branches can be easily observed by “spouting” perfusion liquid and can be efficiently ligated under pressure control. Finally, the vessel which is completely withdrawn from the apparatus, can again be tested for impermeability at an adequate pressure (Δp at least 180 mm Hg) in its entirety.

The perfusion solution of the invention can therefore be utilized in a method for endothelium-preserving treatment of hollow organs or biological vessels. The hollow organs or biological vessels are contacted with the perfusion solution of the invention. The contacting can comprise the thoroughly rinsing, the incubation or the complete or partial treatment of the hollow organ or vessel with the perfusion solution.

The method for endothelium-preserving treatment of hollow organs comprises preferably the use of the apparatus of the invention, which is used to direct perfusion liquid through the hollow organ.

The following figures are intended to illustrate the invention.

### DRAWINGS

FIG. 1 shows an apparatus for use in the method for endothelium-preserving treatment of isolated biological vessels of the invention.

FIG. 2 shows a cultivated endothelial layer from Vena saphena in the course of incubation with saline.

FIG. 3 shows a cultivated endothelial layer from Vena saphena in the course of incubation with a basic composition of the perfusion solution of the invention.

FIG. 4 shows a cultivated endothelial layer from Vena saphena in the course of incubation with a further embodiment of the perfusion solution of the invention.

FIG. 5 shows cultivated venular endothelial cells under influence of releasing products from platelets and granulocytes by subsequent treatment using a perfusion solution of the invention containing quercetin.

FIG. 6 shows cultivated venular endothelial cells under the influence of releasing products from platelets and granulocytes with subsequent treatment using a perfusion solution of the invention containing papaverin.

FIG. 7 shows the reaction of breed cultivated venular endothelial cells from human Vena saphena on cardioplegic potassium concentrations.

FIG. 8 shows the application of the method of the invention and the effect on endothelial coverage in Vena saphena by treatment with isotonic saline solution.

FIG. 9 shows the application of the method of the invention and the effect on endothelial coverage in Vena saphena by treatment with Bretschneider solution.

FIG. 10 shows the application of the method of the invention and the effect on endothelial coverage in Vena saphena by treatment with a 5% albumin solution as perfusion solution.

FIG. 11 shows the application of the method of the invention and the effect on endothelial coverage in Vena saphena by treatment with a blood plasma preparation as perfusion solution.

The following examples illustrate the invention but shall not be understood to limit the same.

### EXAMPLES

The following examples are intended to demonstrate and illustrate the invention. They shall not be understood to be limiting. The skilled person will particularly recognize that the examples can be modified and continued arbitrarily in accordance with the description, and reflect the basic spirit of the invention.

### Example 1

### Preferred Method for Endothelium-Preserving Treatment of Isolated Hollow Organs or Biological Vessels

In one embodiment of the method of the invention, a perfusion solution with the following composition was used when blood vessels were to be treated:

Physiological electrolyte solution with 127 mM NaCl; 4.6 mM KCl; 1.1 mM MgSO₄; 1.2 mM KH₂PO₄; 24 mM histidin-Cl; 2 mM CaCl₂. Prior to addition of CaCl₂ the pH value of the solution was adjusted under atmospheric conditions at pH=7.40. Further, the perfusion solution contained a 10 vol-% lipoprotein-free, hemolysin-free, homologous serum preparation from a pool of blood preparations (obtained from healthy donors), 2.5 mM L-glutamine, 2 mM Na-pyruvate, 8 mM glucose, 200 U/ml penicillin and 0.2 mg/ml streptomycin, low molecular heparin (fraxiparin purchased from Pharmacia Ltd.: 100 μl/100 ml complete solution) and, in addition, 50 μM of each of uric acid and ascorbate.

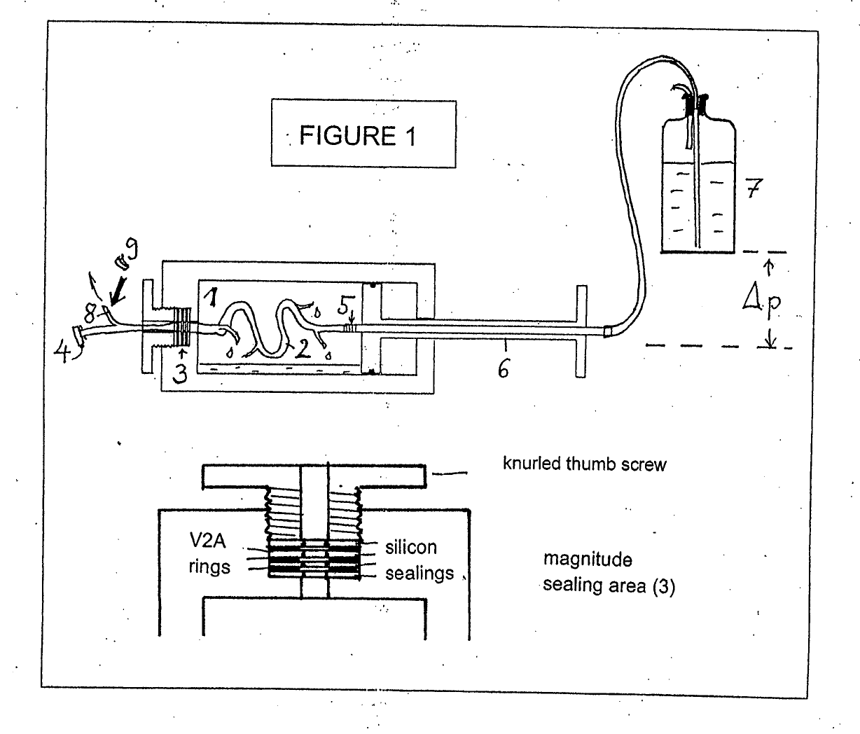

In the method for endothelium-preserving treatment of the isolated biological vessel, an apparatus is used to efficiently ligate the branches of the vessel, which is to be used as bypass implant. The apparatus corresponds substantially to the one described in FIG. 1. The apparatus consists of a chamber (1) and silicon sealing discs with intermediary discs of steel made of V2A steel (3) that are axially arranged with their central perforations in a knurled thumb screw. A short piece of one end of a human Vena saphena was initially pulled through this sealing device, and then ligated by a clamp. The other end of the vessel was connected with the cannula (5) of the stamp portion. The cannula was connected with a flexible tube which in turn was connected with a Boyle Mariott's bottle (7). The Boyle Mariott's bottle contained the above-mentioned endothelium-protective perfusion solution and was placed in a height of about 1.30 m above the chamber in order to generate a natural pressure gradient (Δp). By a defined and constant pressure, the perfusion solution from the Boyle Mariott's bottle was directed through the flexible tube into the cannula and subsequently into the vein. Next, the axially moveable stamp (6) was tightly introduced together with the preceding blood vessel into the interior of the chamber. The endothelium-protective perfusion solution was applied into the vessel under moderate pressure, such that the perfusion solution could flow through the branches of the vessel. In order to seal the leaving region of the vein against the interior of the cylindric chamber, the knurled thumb screw was further screwed into the sealing region (3) into the interior, such that the leaking from the branches in this area was rapidly stopped. By further extracting the vein, perfusion solution selectively spouted from all newly emerging branches which subsequently were immediately ligated. Studies of the intimal surface by scanning electron microscopy demonstrated a complete maintenance (100%) of the endothelial layer.

### Example 2

### Regeneration of Endothelial Tissue from Vena Saphena by Treatment a with One Embodiment of the Endothelium-Preserving Perfusion Solution

In order to demonstrate the efficiency of the endothelium-protective perfusion solution and the method of the invention, isolated endothelial cells obtained from human Vena saphena were microscopically observed during incubation with different embodiments of the perfusion solution of the invention following treatment of the cells and the efficiency was documented by serial or video time-lapse microphotography.

Endothelial cells from non-required rest pieces of human Vena saphena were selectively removed by collagenase incubation and grown in minimal essential medium (e.g. “Dulbecco minimal essential medium”, DMEM) containing 10% v/v fetal calf serum under water vapor-saturated atmospheric environment under addition of 5% v/v carbon dioxide at a temperature of 37° C. (“incubator conditions”) until confluence. Then, the selected plates were placed into an incubation system which was tightly mounted on the object table of a Zeiss Axiovert microscope, which ensured consistency of the above-mentioned growth conditions. The continuous photographic documentation was achieved by means of a computer-controlled Zeiss AxioCam camera using software developed by Zeiss and amber light to achieve sufficient illumination for imaging the respective endothelial layer. Between the individual automatically triggered single images, the cultures were protected by an automatically moveable diaphragm from the light of the microscope lamp.

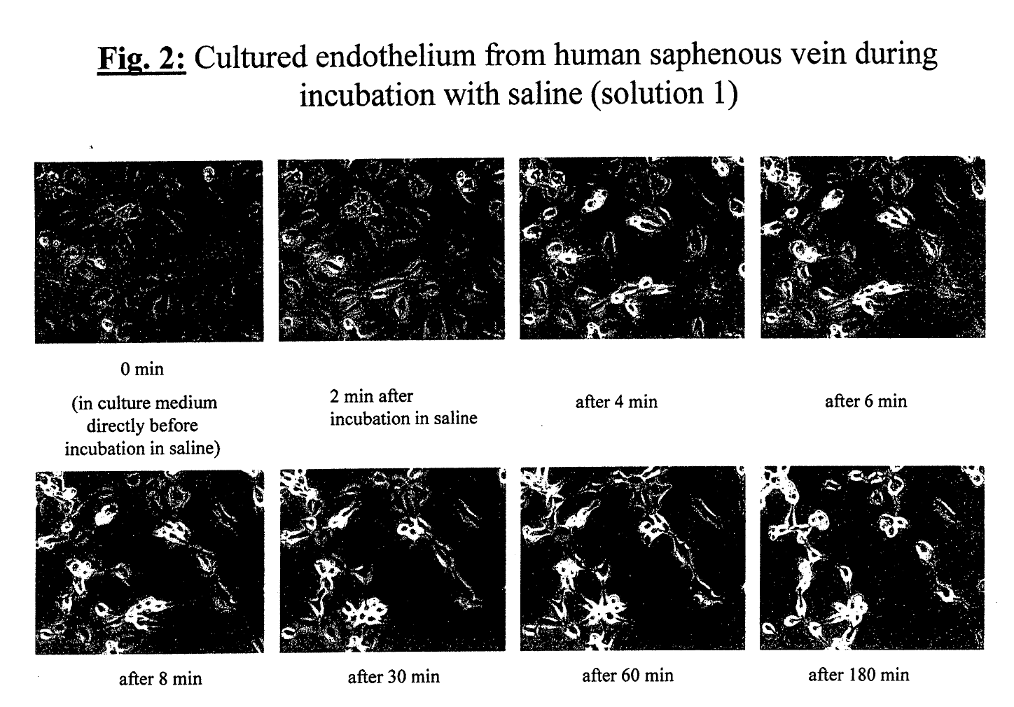

Initially, endothelial cells prepared in this manner were incubated in saline, which was commonly used in this surgical field (FIG. 2; solution 1). The saline had the following composition: 154 mM (0.9% per weight) NaCl in di-distilled water.

The images document the condition of the endothelial cells at different times during incubation with saline. The starting culture (0 minutes) showed an intact endothelial layer. With continuing incubation with saline, endothelial cells were detached in spherical form within few minutes and endothelial cells died. This caused a total destruction of the tissue organization. After an incubation time of 180 minutes, nearly all investigated endothelial cells were detached from the surface in spherical form and were dead.

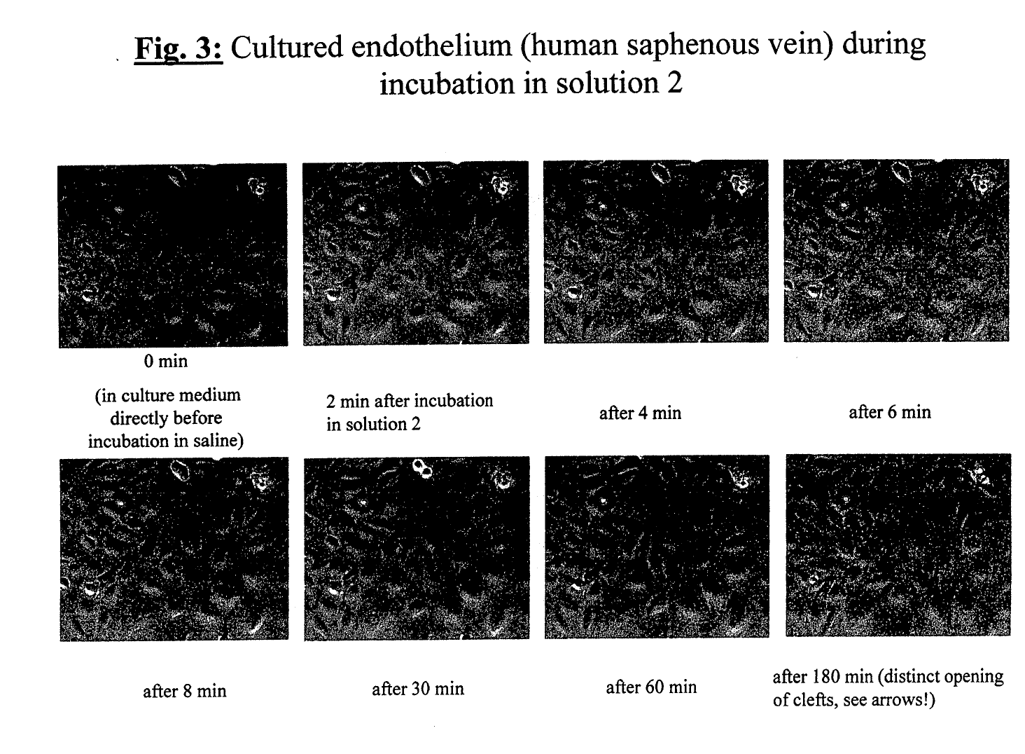

In contrast, treatment of isolated endothelial cells with the perfusion solution of the invention (FIG. 3; solution 2) which contained native albumin resulted in a maintenance of the endothelial cells over the entire observed incubation period. By using this solution, any mitotic activity of the endothelial cells was stopped.

Solution 2 in this example had the following composition: Physiological electrolyte solution (127 mM NaCl; 4.6 mM KCl; 1.1 mM MgSO₄; 1.2 mM KH₂PO₄; 24 mM histidin-Cl; 2 mM CaCl₂. pH to 7.40 before addition of CaCl₂); 0.1% albumin and 2.5 mM L-glutamine. The perfusion solution also contained: 2 mM Na-pyruvate, 8 mM glucose, 200 U/ml penicillin and 0.2 mg/ml streptomycin, low molecular heparin (fraxiparin from Pharmacia Ltd.: 100 μl/100 ml complete solution) and, in addition, 50 μM of each of uric acid and ascorbate.

The incubation of cultivated endothelial cells in solution 2 resulted in a nearly complete maintenance of the endothelial tissue architecture and a high density of the cellular layer. In particular, neither ablation in spherical form nor dying of the endothelial cells was observed. After about 180 minutes, there was a remarkable expansion of the intracellular spaces between some endothelial cells. However, it could be shown, that the function of the endothelial tissue, in particular the protection of the subendothelial regions of the vessel wall is kept maintained in this perfusion solution. Thus, this perfusion solution of the invention, without serum, effects a complete maintenance of vitality of endothelial cells wherein at the same time their most important function is maintained.

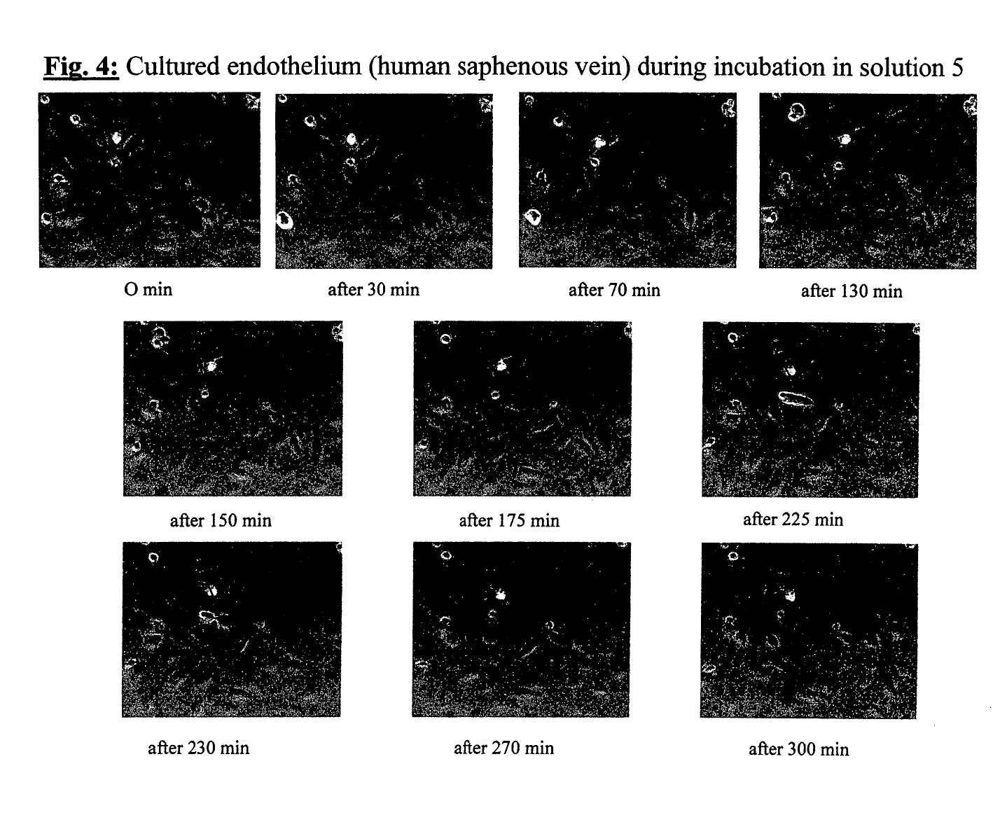

In a further experiment, the potential for regeneration of the endothelial cells was investigated by treatment with the serum-containing perfusion solution of the invention. The isolated and cultured endothelial cells were treated with a perfusion solution (FIG. 4; solution 5).

This serum-containing solution (solution 5) had the following composition: Physiological electrolyte solution with 127 mM NaCl; 4.6 mM KCl; 1.1 mM MgSO₄; 1.2 mM KH₂PO₄; 24 mM histidin-Cl; 2 mM CaCl₂. Prior to addition of CaCl₂ the pH value of the solution was adjusted under atmospheric environment at pH=7.40. Further, the perfusion solution contained 10 vol-% lipoprotein-free, hemolysin-free, homologous serum preparation from a pool of blood preparations, 2.5 mM L-glutamine, 2 mM Na-pyruvate, 8 mM glucose, 200 U/ml penicillin and 0.2 mg/ml streptomycin, low molecular heparin (fraxiparin from Pharmacia Ltd.: 100 μl/100 ml ready solution) and, in addition, 50 μM of each of uric acid and ascorbate.

Contrary to solution 2, solution 5 contained homologous serum instead of albumin. This effects not only a remarkable effect on maintenance of the structure of the tissue of endothelial cells but also increases the capability of the cultivated endothelial cells for cell division.

Even after an incubation time of 30 minutes in solution 5, cell divisions of endothelial cells could be observed. The cell division competence of endothelial cells was maintained over the entire investigation period. The incubation of endothelial cells in solution 5 therefore resulted in a proliferation of endothelial cells and hence contributed to the regeneration capability of the endothelial layer.

These data demonstrate the advantages of the perfusion solutions of the invention as compared to the commonly used solutions such as saline solution or Bretschneider solution. The perfusion solution of the invention results on the one hand in a maintenance of endothelial cell tissue and on the other hand promotes the capability of the endothelial cells to divide. This is in particular desirable with regard to the regeneration of damaged endothelial layers in biological vessels and for the preparation or generation of biological vessels or vascular implants. In addition, the perfusion solution of the invention has the remarkable property that the biological vessels can be stored for several weeks in the perfusion solution without damaging or affecting the endothelial layer.

### Example 3

### Preferred Perfusion Solution or Incubation Solution which Includes Quercetin

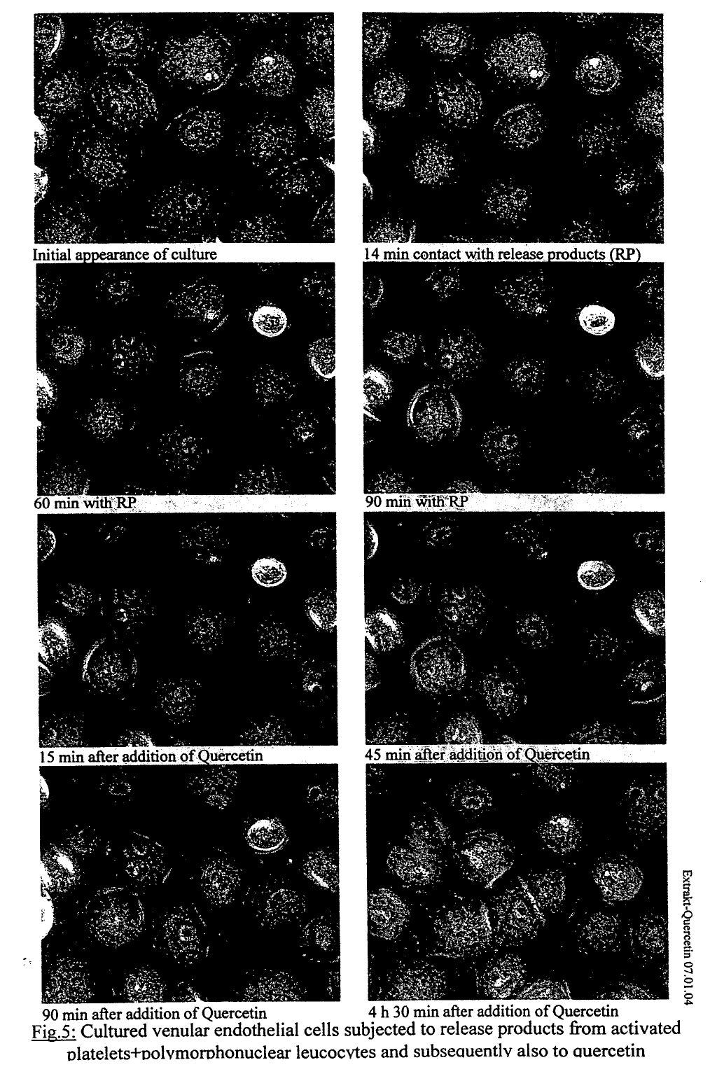

In the following example, the effect of quercetin, a naturally occurring anti-inflammatory-acting flavonoid on the endothelium of the smallest body vein (venules) was investigated in detail (see FIG. 5). To do this, different isolated human hearts of donors were rinsed thoroughly in the presence and absence of quercetin. This solution had the following composition: Isotonic electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 prior to addition of CaCl₂); 0.1% albumin and 2.5 mM L-glutamine. The perfusion solution also contained: 2 mM Na-pyruvate, 8 mM glucose, 200 U/ml penicillin and 0.2 mg/ml streptomycin, low molecular heparin (fraxiparin from Pharmacia Ltd.: 100 μl/100 ml complete solution) and, in addition, 100 μM freshly added quercetin.

For the investigation of myocardial arteries and venules (which are particularly effected by an occlusion), a proteolytic isolation of the arteriola and venules on the human donor heart and purification was performed by isopycnic centrifugation. The endothelial cells were kept in culture. For measurement of the hydraulic conductivity, cultures of endothelial cells were established on polycarbonate filters.

FIG. 5 shows a series of 8 pictures of cultivated venular endothelial cells of the human heart and the effect of quercetin on the endothelium: In the starting situation (starting culture), the cells were treated with the above-described basic solution without quercetin. The starting culture shows a dense cell layer. In the course of incubation, this layer was brought to contraction and in consequence to leakage effected by the contractile releasing products from activated platelets and granulocytes of human blood, which resulted in open areas in the endothelial layer. Following addition of quercetin, a regeneration of the endothelial layer could be observed which became equally dense in the course of incubation in the quercetin-containing perfusion solution as in the starting culture. The endothelial layer which was treated by this incubation solution (including quercetin) showed a >98% density of the intracellular spaces and a very low hydraulic conductivity <1[m×10⁻⁶×s⁻¹ cm H₂O].

This demonstrates that in the presence of quercetin in the perfusion solution, the regeneration of endothelial lesions, which are caused by the releasing products of activated and metabolically cooperating granulocytes and thrombocytes, is facilitated, and contributes to the maintenance of the endothelium. This solution is therefore useful for organ and vessel preservation with the purpose of endothelium maintenance in the lumen of the vessels.

### Example 4

### Preferred Perfusion Solution or Incubation Solution which Includes Rutosides

Similar to the solution described above in Example 3, another flavonoid, trihydroxyethyl rutoside, was added to the otherwise identical basic solution instead of quercetin.

The endothelial organization here, too, was destroyed by the activity of activated granulocytes and platelets.

Similar to the results in Example 3, the presence of a flavonoid in the basic solution resulted in a remarkable regeneration of the endothelial layer in the isolated vessels, which showed a >98% density of the intercellular spaces and a very low hydraulic conductivity <1[m×10⁻⁶×s⁻cm H₂O].

These two examples show that flavonoids prevent or even cure the destruction of the endothelium in vessels caused by the releasing products of granulocytes and thrombocytes in inflammation reactions.

### Example 5

### Preferred Perfusion Solution or Incubation Solution which Includes Vasorelaxing Papaverin

Even at bypass surgeries, veins that are operated freshly from the lower leg frequently develop spasms that then can be burst by “blowing up” the veins with isotonic saline solution, which is injected under high pressure. In this respect, not only the subtle cellular junctions of the vascular musculature are burst, but also the cellular junctions of the luminal vascular endothelium which, as a result of this treatment, died and were washed off. By addition of an effective vasodilator to the basic solution of the perfusion solution of the invention, the formation of spasms until implantation in the vein preparation can be prevented.

The utilized solution in this example had the following composition: Isotonic electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 before addition of CaCl₂); 0.1% albumin and 2.5 mM L-glutamine. The perfusion solution also contained: 2 mM Na-pyruvate, 8 mM glucose, 200 U/ml penicillin and 0.2 mg/ml streptomycin, low molecular heparin (fraxiparin from Pharmacia Ltd.: 100 μl/100 ml complete solution) and, in addition, 100 μM freshly added quercetin.

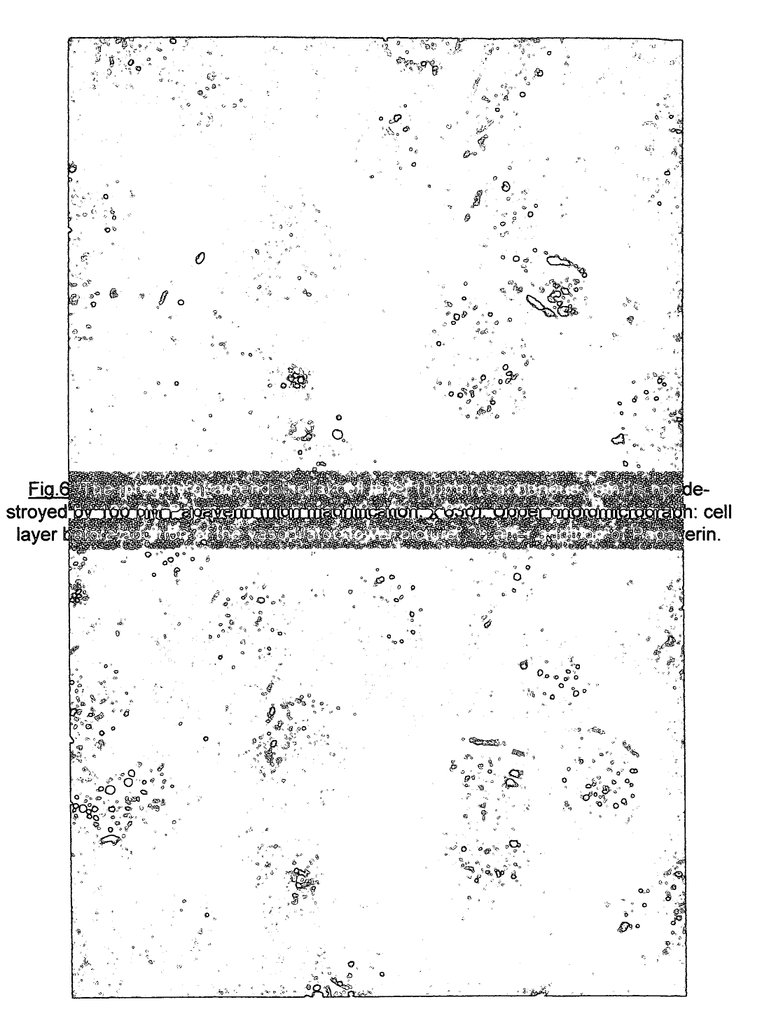

FIG. 6 shows the endothelial layer of isolated body vein segments before and 3 hours after incubation in papaverin-containing medium. The presence of a vasodilator such as papaverin in the incubation solution did not result in any impairment of the impermeability of the vascular endothelium. In this regard, FIG. 6 shows a photograph of the endothelial layer with a 630-fold magnification.

The above panel of FIG. 6 shows the endothelial layer immediately before the addition of papaverin. The lower panel shows the condition of the endothelium 3 hours after addition of papaverin.

It was further found that 7 of 18 investigated vein segments that were previously treated with isotonic saline solution, developed such a strong spasm that a perfusion under normal arterial average pressure (100 mm Hg) was not possible anymore. No single vein from the 18 veins showed a spasm following storage in the above-mentioned solution, i.e. the veins were freely permeable.

The endothelium treated with the above-mentioned perfusion solution exhibited a remarkable impermeability (>98%) of the intracellular spaces and a very low hydraulic conductivity <1[m×10⁻⁶×s⁻¹cm H₂O].

Thus, a vasodilator can be conveniently added during vascular and organ transplantations and may contribute to the prevention of formation of spasms in addition to the maintenance of the endothelium. Finally, also the relaxation of the musculature of an organ or vessel to be transplanted is desirable to make the handling by a surgeon and the application of the organ in the body more convenient.

### Example 6

### Preferred Perfusion Solution or Incubation Solution which Includes Adenosine

Analogous results to those described in Example 5 have been obtained by the use of adenosine, as agent for the prevention of spasms.

Adenosine is a physiologically occurring compound which has the capability for a strong relaxation of vessels such as veins (similar to papaverin in Example 5). The advantage of adenosine is that this nucleoside can be degraded so that no systemic effects on the coronary circulation is expected to occur. The solution as used in this example had the same composition as described in Example 5, however, it contained 1 mM adenosine instead of papaverin. The experiments that have been carried out as well as the subsequent investigation in cell cultures and isolated vein segments revealed an excellent density of the endothelial layer. This can inter alia be explained by the fact that adenosine is used to a great extent for the full physiological production of the ATP pool of the vascular endothelium and is therefore available as energy donor (similar to pyruvate and glucose in other embodiments of the perfusion solution of the invention).

In addition, it should be noted that the ATP levels of endothelial cells in the above-mentioned basic solution (without adenosine) were 4.25±0.36 mM (n=6), 5.33±0.48 mM (n=7) in the presence of adenosine. This suggests an optimal energetic situation in the endothelium.

Therefore, the presence of adenosine in the incubation solution did not result in any impairment of the impermeability of the vascular endothelium by the vasodilator both in cell cultures and isolated vein segments. This solution is therefore suitable for the preservation of endothelium in vessels and organs, and, at the same time, for the prevention of formation of spasms.

### Example 7

### Preferred Perfusion Solution or Incubation Solution which Includes Growth Factors (EGF, bFGF)

In this example, a perfusion solution was used which contained growth factors (bFGF, EGF) and growth hormones (hydrocortisone). These factors have beneficial influence on the proliferation of endothelial cells from different vascular origins.

The perfusion solution used in this example had the following composition: Isotonic electrolyte solution (127 mM NaCl; 4.6 mM KCl; 1.1 mM MgSO₄; 1.2 mM KH₂PO₄; 24 mM histidin-Cl; 2 mM CaCl₂ (pH to 7.40 before addition of CaCl₂); 0.1% albumin and 2.5 mM L-glutamine. The perfusion solution also contained: 2 mM Na-pyruvate, 8 mM glucose, 200 U/ml penicillin and 0.2 mg/ml streptomycin, low molecular heparin (fraxiparin from Pharmacia Ltd.: 1001/100 ml complete solution). In addition, the solution contained 0.1-1 ng/ml epidermal growth factor (EGF), 0.2-2 ng/ml basic fibroblast growth factor (bFGF) and hydrocortisone 0.2-3 μg/ml.

The results of these studies show that the density of the endothelial cell layer in this medium was >98%. The generation time of cells without growth factors was 62 h±4, the generation time with growth factors was 19 h±3 (each n=8). Therefore, the endothelial cells showed a remarkable decreased generation time in this medium as compared to the control solution which did not contain growth factors.

### Example 8

### Preferred Perfusion Solution or Incubation Solution which Includes Cardioplegically Acting KCl

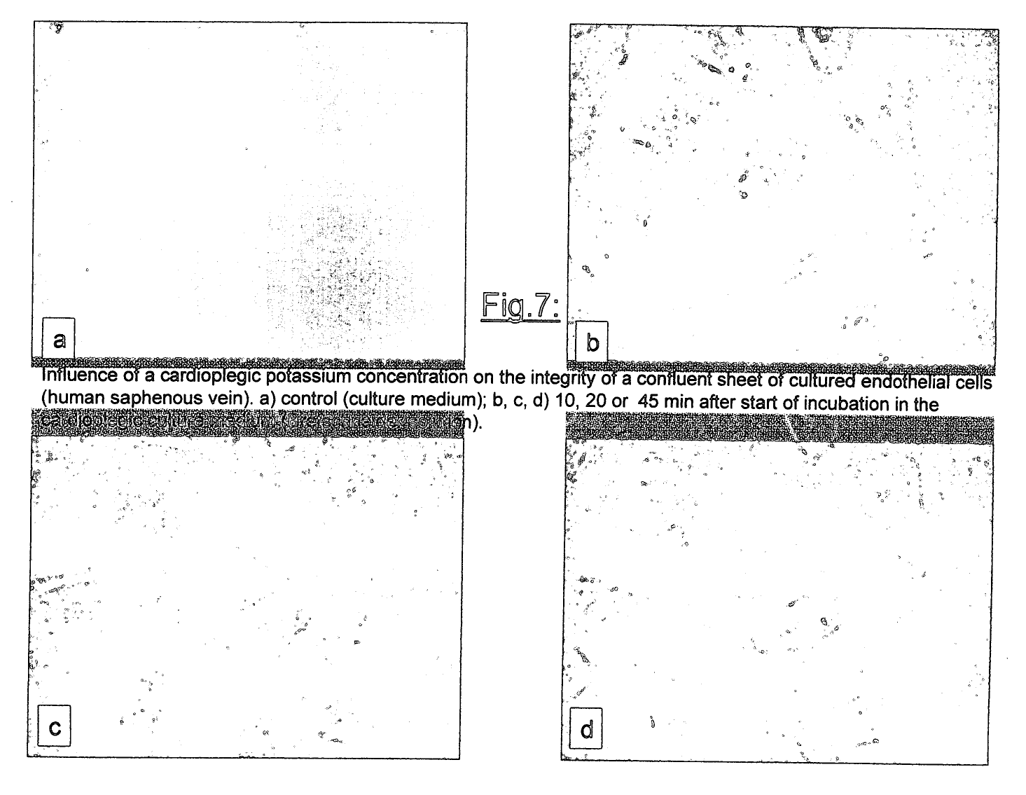

In this example, the reaction of grown endothelial cells from human Vena saphena as a result of cardioplegic potassium concentrations was investigated (see FIG. 7).

The physiological concentration of potassium in blood plasma was about 4-5 mM. If the concentrations of potassium in the extracellular space are increased to concentrations at >6 mM (cardioplegic solution), an increasing paralysis of the electrical activity can be observed which is complete at about 8 mM. A heart can the not beat anymore. In coronary surgery such perfusion solutions are utilized in order to relax the heart during surgery (e.g. in a heart transplantation).

In this example, human pool plasma was dialyzed for 2 days against the following solution (which is commonly utilized in coronary surgery as cardioplegic solution—“Bretschneider solution”): 15 mM NaCl, 10 mM KCl, 4 mM KCl, 4 mM MgCl₂, 0.015 mM CaCl₂, 1 mM α-cetoglutaric acid, 198 mM histidin, 2 mM L-tryptophan, 30 mM mannitol, adjusted to pH=7.4 with HCl. The dialyzed solution was sterilely filtrated and used for treatment as described above.

FIG. 7 shows a reaction of grown endothelial cells of human origin as a result of high concentration of potassium in the solution in time course. This results in a remarkable formation of crevices in the intracellular regions but does not cause a detachment of cells. Systematic perfusion tests at isolated bovine hearts were performed following perfusion with

1. (crystalloid) Bretschneider solution containing 0.1% Evans Blue (control)

2. Evans Blue perfusion solution used in analogous manner.

The results show that the dye content which is related to the corresponding weight of the heart rinsed in the heart thoroughly with the perfusion solution described above was in average 16±3.5% (n each=6) over the control (Bretschneider solution). In other words: about 16% additional myocard survived upon treatment with the incubation solution of the invention. These results provide evidence that the perfusion of the myocard by addition of plasma proteins can be improved by the same magnitude.

These results clarify that the endothelial cells open their intracellular spaces in intact vein segments and in cell culture if concentrations of potassium are used that are unavoidably high in coronary surgery, but they did not become rounded and they stayed attached to the respective subsurface for several hours. The high levels of plasma proteins in the perfusion solution of the invention allow that the cardioplegic solution can also perfuse into smallest capillaries resulting in an uniform stagnancy of muscle activity in all regions of the myocard. This will result in an equal survival of all regions of the heart tissue.

The use of the above described cardioplegic solution resulted in a remarkably improved endothelial density, improved endothelium maintenance and also a more consistent, more homogonous perfusion and maintenance of the myocard.

### Example 9

### Regeneration of Endothelial Tissue from Vena Saphena by Treatment with a Blood Plasma Preparation as Endothelium-Protective Perfusion Solution

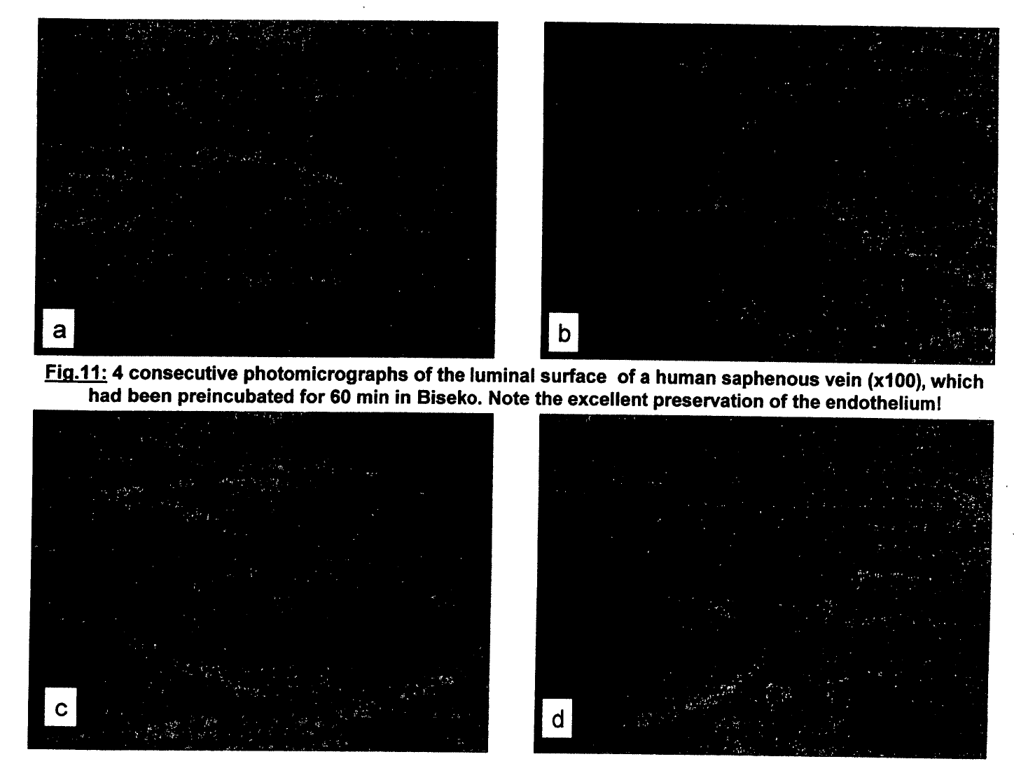

In the following example, the effect of one embodiment of the perfusion solution of the invention, which is derived from a blood plasma preparation, on the endothelial tissue from isolated Vena saphena segments was investigated (FIG. 11).

The utilized blood plasma preparation contained the following composition: 150 mM sodium ions, 3.65 mM potassium ions, 1.97 mM calcium ions, 1 mM magnesium ions, 107 mM chloride ions, 32 g/l albumin, immunoglobulins IgG 7 g/l, IgA 1.7 g/l and IgM 0.5 g/l and 51 g/l total protein and nutrient and energy substrates that are naturally present in blood plasma. The blood plasma preparation was further treated with β-propiolactone and UV for virus inactivation.

Confocal microscopy was carried out on isolated vein segments as described in the other examples. Vena saphena was treated with the blood plasma preparation for 60 minutes. As control solutions, saline or Bretschneider solution was used. The treatment with these control solutions has resulted in drastic endothelial lesions (Lp of cultivated endothelial cells=1.2+/−0.3 cm×10⁻⁶×s⁻¹×cm H₂O; n=5) and a strong detachment of endothelial cells from the vessel walls was observed already after an incubation time of 30 minutes.

The treatment with the blood plasma preparation (n=141) resulted in no detachment of endothelial cells but in a dense endothelial tissue. The endothelium of Vena saphena segments remains attached to the vessel wall. The tissue factor TF is hardly measurable in veins that are treated with the perfusion solution of the invention (2,6 ml×min⁻¹cm⁻²+/−1.5; n=5) after incubation (1 h), but very high in the control solutions (8.2 fmol×min⁻¹×cm⁻²+/−3.3; n=5). This can be explained by coagulation factors which increasingly contact pericyte-like cells by means of open endothelial crevices.

These results show that the perfusion solution of the invention in any embodiment is able to preserve or regenerate the luminal endothelium of the vessels and organs and have the capability to provide for a long opening rate and hence long-term function of the hollow organs and long lifetime of implants.

### Example 10

### Embodiment of One Blood Plasma Preparation as Perfusion Solution which Includes Papaverin

The same results as described in Example 10 were obtained with a perfusion solution (blood plasma preparation of Example 9) which additionally contained 10 μM papaverin as vasodilator. In addition to the maintenance of the endothelial layer, the formation of spasms could be reduced or prevented by the addition of papaverin.

### Example 11

### Embodiment of the Blood Plasma Preparation as Perfusion Solution which Includes KCl (Cardioplegic Perfusion Solution)

In similar manner, also the electric activity could be prevented with a cardioplegic perfusion solution (blood plasma preparation of Example 9) in isolated hearts. Die utilized solution contained 20 mM KCl rather than the KCl concentrations indicated in the basic solution of the blood plasma preparation.

This solution is well suitable for the protection of the endothelium during surgeries and is capable to relax the implant (e.g. vessel, organ) by incubation in the cardioplegic perfusion solution as a result of the high content of potassium.

### Example 12

### In Vivo Studies in Bypass Patients

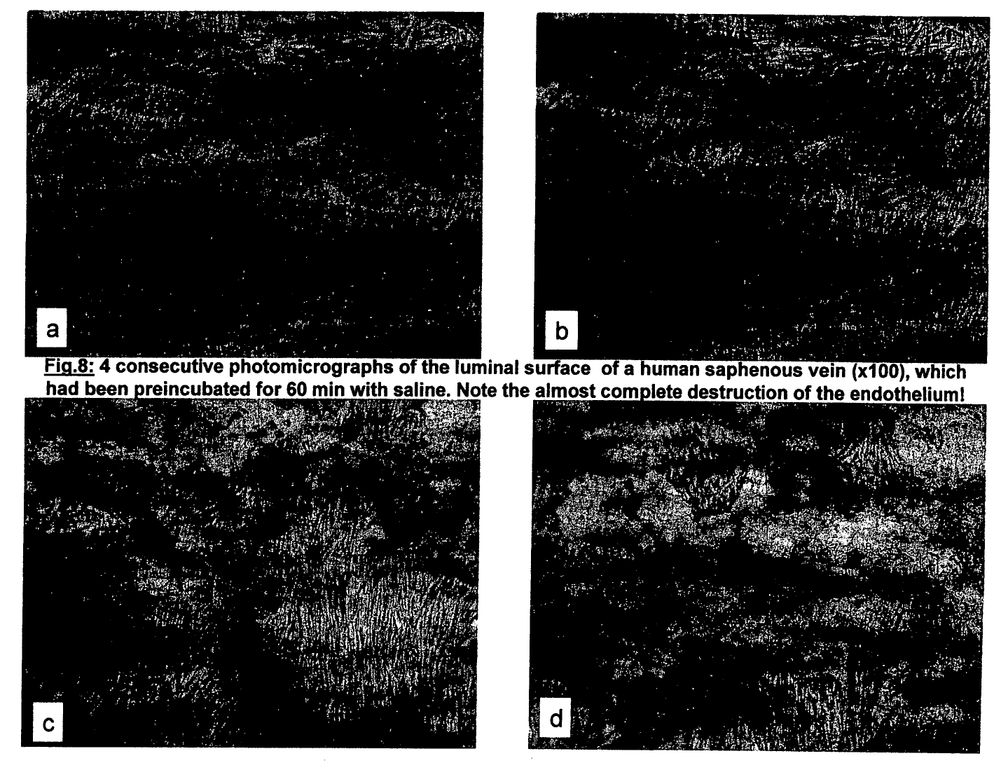

In order to demonstrate the transferability of the results showed so far in living patients, a study was carried out in hospitalized bypass patients (FIGS. 8-11).

The in vivo study was carried out in a way that each of 25 freshly explanted Vena saphena from bypass patients was rinsed thoroughly with one of the four following solutions and was then incubated for about 30-60 minutes in the same solution at room temperature until transplantation:

1. Isotonic saline solution as control (FIG. 8)

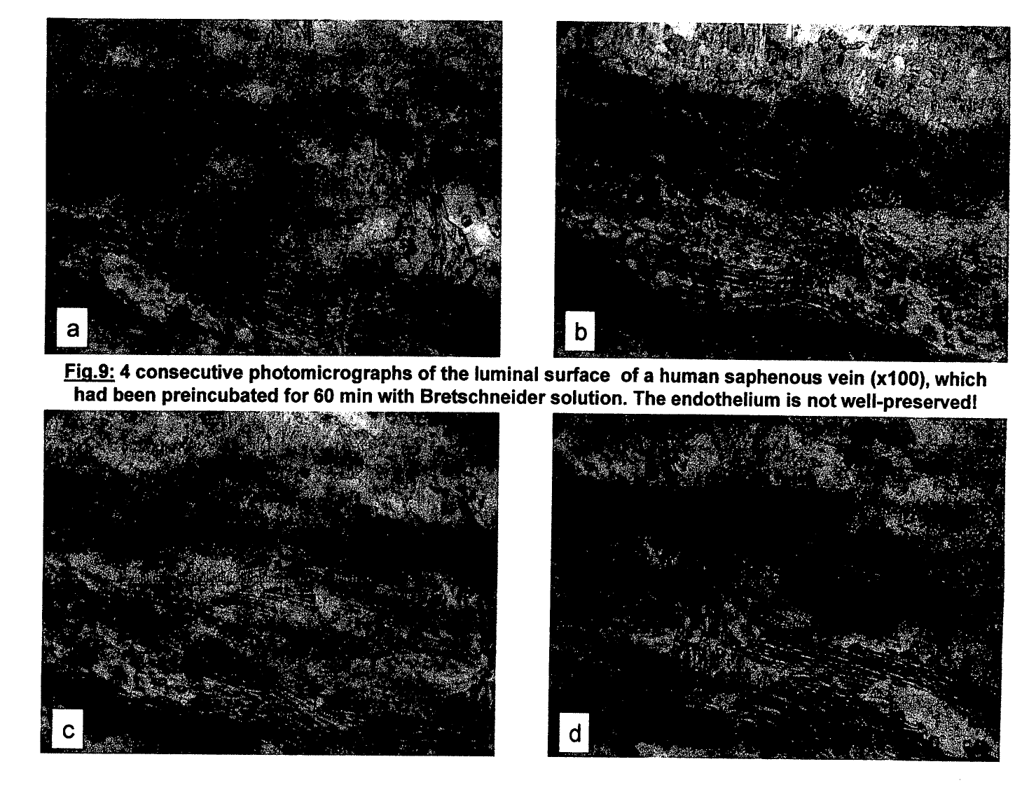

2. Bretschneider solution (cardioplegic) as control (FIG. 9)

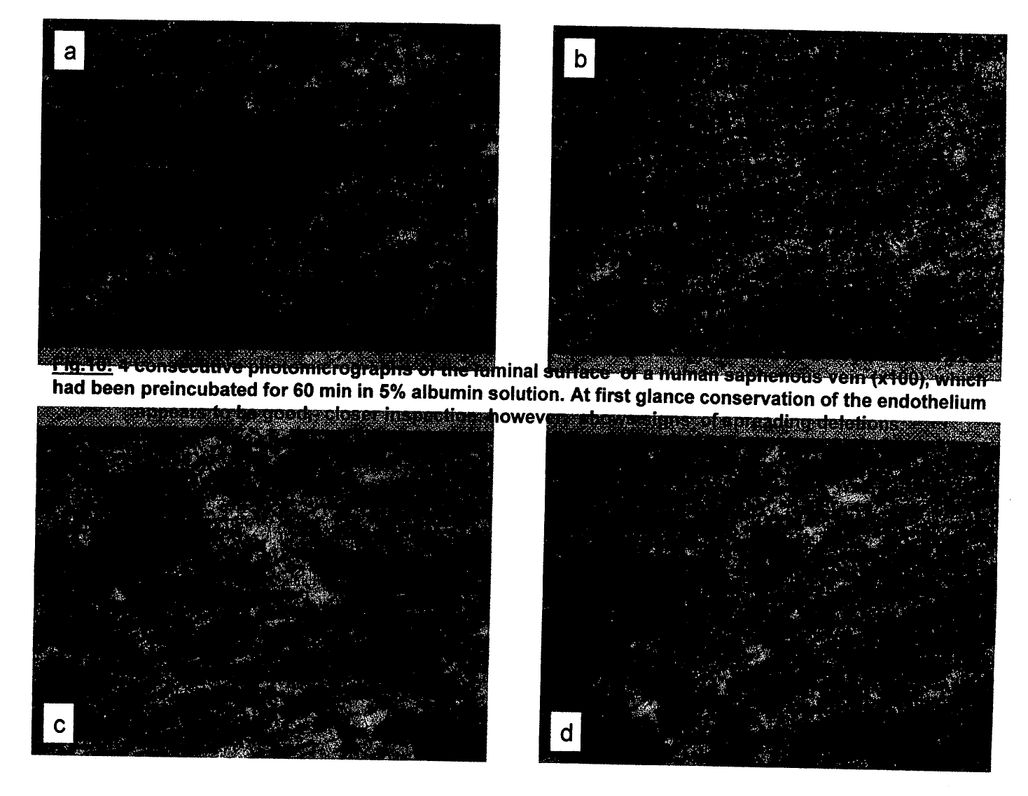

3. Isotonic perfusion solution of Example 2 with 5% albumin (FIG. 10)

4. Blood plasma preparation (corresponding to Example 9; FIG. 11)

Immediately after explantation and thoroughly rinsing with the above-mentioned solutions (solutions 1-4 in this example; FIGS. 8-11) and directly after incubation in these solutions but directly before transplantation (i.e. about 30-60 minutes after explantation) pieces having a length of about 5 mm of the respective vein segment were cut and fixed in formaldehyde/glutaraldehyde solution. For control purposes, a portion of the vein segment was incubated for a total of 8 hours in the respective incubation solution, but the main portion of the vein was implanted. In the fixed portion segments, silver impregnation of cellular spaces was carried out so that the integrity of the endothelium of the vascular intima could be quantitatively determined at different time points. It was shown that in solutions 1 and 2 (saline or Bretschneider solution) the endothelial coverage of the vessels was often not observable and in most cases only small areas persisted (FIGS. 8-9). Subendothelial intermediate wall layers were directly associated with the lumen. The grown endothelial cells and also the endothelium in intact veins incubated in solutions 1 and 2 were well permeable for aqueous medias which were applied into the lumen under slight overpressure because of their endothelial spaces. A resulting transmural transport of water could be detected, the magnitude of which could be exactly measured as hydraulic conductivity.

An incubation with the perfusion solutions of the invention 3 and 4 resulted in only a low and in the case of perfusion solution 4 a very low hydraulic conductivity providing evidence for the high impermeability and continuity of the endothelial coverage (FIGS. 10-11).

In parallel experiments, it was determined how one of the factors contained in the above-described solutions are activated by the tissue factor (TF) localized in the lower wall layers after incubation of longer vein segments with one of the four above-described solutions and subsequent rinsing with a standardized mixture of coagulation factors (BBSB). The latter is most likely responsible for all clinically occurring intravasale thrombosis events. Normally, the tissue factor is protected from blood by the intact vascular endothelium (and as consequence from the coagulation factors in the plasma). This also appears, if the veins had been initially incubated with a perfusion solution of the invention. In the cases where the control solutions 1 and 2 were used, the wall was found to be prothrombogenic, because the intravasale coagulation factors could diffuse through the incomplete endothelium into the lower wall layers and then came into contact with the tissue factor.

Similar results were also obtained with Arteria mammaria int. bypasses (not shown), which demonstrates that the methods of the invention are not restricted to any specific type of vessel or organ.

In summary, the present invention provides a method for treatment, production and preservation of isolated hollow organs and biological vessels in surgeries, transplantations, during transport and incubation. The hollow organs or biologic vessel treated with one of the herein described perfusion solutions of the invention are thus suitable for vascular or organ implants (e.g. bypass) providing long lifetime and functionality. The still high risk of a restenosis in such implants is remarkably reduced by using a perfusion solution of the invention, and thus contributes to the well-being of the patient.

1. A method for the endothelium-preserving treatment of hollow organs, comprising contacting an isolated hollow organ with an endothelium-protective perfusion solution, wherein the endothelium-protective perfusion solution comprises at least the following components:
(a) physiological electrolyte solution
(b) at least about 0.1% per weight of native albumin
(c) nutrient substrate;
wherein the treatment results in a preservation or repair of the endothelial tissue in the lumen of said hollow organ.

2. The method of claim 1, wherein said native albumin in said endothelium-protective perfusion solution is replaced by about 1-10 vol-% homologous hemolysin-free serum or autologous serum.

3. The method of claim 1, wherein said native albumin in said endothelium-protective perfusion solution is replaced by a homologous anti-coagulatory blood plasma preparation, which comprises human plasma proteins, anti-coagulatory-acting factors and immunoglobulins, and in which the pro-coagulatory-acting factors, isoagglutinins and unstable components of the blood plasma have been removed.

4. The method of claim 3, wherein the anti-coagulatory blood plasma preparation contains sodium ions, potassium ions, calcium ions, magnesium ions, chloride ions, human serum proteins, albumin and immunoglobulins.

5. The method of claim 4, wherein the anti-coagulatory blood plasma preparation comprises the following composition: about 100-170 mM sodium ions, about 1-15 mM potassium ions, about 1-6 mM calcium ions, about 0.1-4 mM magnesium ions, about 50-200 mM chloride ions, human serum proteins with about 25-45 g/l albumin, about 3-15 g/l IgG, about 1-10 g/l IgA and about 0.2-3 g/l IgM immunoglobulins at a pH value of about 7.3 to about 7.8 and an osmolarity of about 200-350 mosmol/kg.

6. The method of claim 1, wherein said nutrient substrate in said endothelium-protective perfusion solution is L-glutamine.

7. The method of claim 6, wherein the concentration of L-glutamine in said endothelium-protective perfusion solution is about 0.5-10 mM.

8. The method of claim 6, wherein said physiological electrolyte solution is selected from the group consisting of about 2-10 mM glucose and/or and about 1-10 mM pyruvate.

9. The method of claim 6, wherein said physiological electrolyte solution is selected from the group consisting of about 0.1-0.6 U/ml heparin, about 50-100 μM of uric acid and about 50-100 μM of ascorbate.

10. The method of claim 6, wherein said physiological electrolyte solution comprises the following components: about 100-150 mM NaCl; about 1-15 mM KCl; about 0.1-4 mM MgSO₄; about 0.5-2 mM KH₂PO₄; about 24-48 mM histidin-Cl and about 1-3 mM CaCl₂.

11. The method of claim 1, wherein the endothelium-protective perfusion solution is an anti-coagulatory and non-agglutinating blood plasma preparation, comprising human plasma proteins, anti-coagulatory-acting factors and immunoglobulins, and in which the pro-coagulatory-acting factors, isoagglutinins and unstable components of the blood plasma have been removed.

12. The method of claim 11, wherein the blood plasma preparation comprises the following components: about 100-170 sodium ions, about 1-15 mM potassium ions, about 1-6 mM calcium ions, about 0.1-4 mM magnesium ions, about 50-200 mM chloride ions, about 25-45 g/l albumin, about 3-15 g/l IgG, about 1-10 g/l IgA and about 0.2-3 g/l IgM immunoglobulins.

13. The method of claim 12, wherein the blood plasma preparation was treated with β-propiolactone and UV-radiation for virus inactivation.

14. The method of claim 1, wherein said perfusion solution contains one or more endothelium-promoting growth factors.

15. The method of claim 14, wherein said growth factor is selected from the group consisting of epidermal growth factor (EGF), fibroblast growth factor (FGF), vascular endothelial growth factor (VEGF) and stem cell factor (SCF).

16. The method of claim 1, wherein said perfusion solution contains flavonoids.

17. The method of claim 16, wherein the flavonoid is quercetin or trihydroxyethyl rutoside.

18. The method of claim 1, wherein said perfusion solution contains papaverin or adenosine.

19. The method of claim 1, wherein said perfusion solution contains cardioplegic concentrations of potassium of more than about 6 mM.

20. The method of claim 1, wherein said hollow organ is selected from the group consisting of a heart, intestine, uterus, kidney, bladder, lung, liver and spleen.

21. The method of claim 1, wherein said hollow organs are biological vessels.

22. The method of claim 21, wherein said biological vessels are blood vessels or lymphatic vessels.

23. (canceled)

24. An endothelium-protective perfusion solution comprising:
(a) physiological electrolyte solution
(b) at least about 0.1% per weight of native albumin
(c) about 0.5 to 10 mM L-glutamine.

25. The perfusion solution of claim 24, wherein said native albumin is replaced by about 1-10 vol-% homologous hemolysin-free serum or autologous serum.

26. The perfusion solution of claim 24, wherein said native albumin in the endothelium-protective perfusion solution is replaced by a homologous anti-coagulatory blood plasma preparation, comprising human plasma proteins, anti-coagulatory-acting factors and immunoglobulins, and in which the pro-coagulatory-acting factors, isoagglutinins and unstable components of the blood plasma have been removed.

27. The perfusion solution of claim 26, wherein the anti-coagulatory blood plasma preparation contains sodium ions, potassium ions, calcium ions, magnesium ions, chloride ions, human serum proteins, albumin and immunoglobulins.

28. The perfusion solution of claim 27, wherein the anti-coagulatory blood plasma preparation comprises the following composition: about 100-170 mM sodium ions, about 1-15 mM potassium ions, about 1-6 mM calcium ions, about 0.1-4 mM magnesium ions, about 50-200 mM chloride ions, human serum proteins with about 25-45 g/l albumin, about 3-15 g/l IgG, about 1-10 g/l IgA and about 0.2-3 g/l IgM immunoglobulins at a pH value of about 7.3 to about 7.8 and an osmolarity of about 200-350 mosmol/kg.

29. The perfusion solution of claim 24, wherein the concentration of L-glutamine is about 2.5 mM.

30. The perfusion solution of claim 24, wherein the concentration of L-glutamine is about 5 mM.

31. The perfusion solution of claim 24, wherein the concentration of L-glutamine is about 7.5 mM.

32. The perfusion solution of claim 24, wherein said physiological electrolyte solution comprises the following components: about 100-150 mM NaCl; about 1-15 mM KCl; about 0.1-4 mM MgSO₄; about 0.5-2 mM KH₂PO₄; about 2448 mM histidin-Cl and about 1-3 mM CaCl₂.

33. The perfusion solution of claim 32, wherein said physiological electrolyte solution contains about 2-10 mM glucose or about 1-10 mM pyruvate.

34. The perfusion solution of claim 24, wherein said physiological electrolyte solution is selected from the group consisting of about 0.1-0.6 U/ml heparin, 50-100 μM of uric acid and about 50-100 μM of ascorbate.

35. The perfusion solution of claim 24, wherein the pH value in said physiological electrolyte solution is about 7.4+/−about 0.04 under atmospheric condition.

36. The perfusion solution of claim 24, wherein said endothelium-protective perfusion solution further contains antibiotics.

37. The perfusion solution of claim 36, wherein said antibiotics are about 50-400 U/ml penicillin or about 0.1-0.4 mg/ml streptomycin.

38. The perfusion solution of claim 24, wherein said perfusion solution is an anti-coagulatory and non-agglutinating blood plasma preparation, comprising human plasma proteins, anti-coagulatory-acting factors and immunoglobulins, and in which the pro-coagulatory-acting factors, isoagglutinins and unstable components of the blood plasma have been removed.

39. The method of claim 38, wherein the blood plasma preparation comprises the following components: about 100-170 sodium ions, about 1-15 mM potassium ions, about 1-6 mM calcium ions, about 0.1-4 mM magnesium ions, about 50-200 mM chloride ions, about 25-45 g/l albumin, about 3-15 g/l IgG, about 1-10 g/l IgA and about 0.2-3 g/l IgM immunoglobulins.

40. The perfusion solution of claim 39, wherein the blood plasma preparation was treated with β-propiolactone and UV-radiation for virus inactivation.

41. The perfusion solution of claim 24, wherein said perfusion solution contains one or more endothelium-promoting growth factors.

42. The perfusion solution of claim 41, wherein said growth factor is selected from the group consisting of epidermal growth factor (EGF), fibroblast growth factor (FGF), vascular endothelial growth factor (VEGF) and stem cell factor (SCF).

43. The perfusion solution of claim 24, wherein said perfusion solution contains flavonoids.

44. The perfusion solution of claim 43, wherein the flavonoid is quercetin or trihydroxyethyl rutoside.

45. The perfusion solution of claim 24 any one of claims 25-44, wherein said perfusion solution contains papaverin or adenosine.

46. The perfusion solution of claim 24, wherein said perfusion solution contains cardioplegic concentrations of potassium of more than about 6 mM.

47. An apparatus for the endothelium-preserving treatment of isolated biological vessels comprising a chamber, an axially movable stamp, a cannula, a reservoir container, which contains an endothelium-preserving perfusion liquid and a sealing device, wherein the cannula is connected with the axially moveable stamp such that the cannula can be moved together with the stamp into the chamber, and wherein the sealing device can clasp one end of the vessel and the cannula is connected with the other end of the vessel such that the endothelium-protective perfusion solution can be selectively directed into the biological vessel from the reservoir container, preferably under a pressure gradient.

48. The apparatus of claim 47, wherein said sealing device comprises sealing discs which are arranged in stacks in a knurled thumb screw.

49. The apparatus of claim 48, wherein the sealing discs have a diameter of about 1-10 mm and/or a thickness of about 0.3-3 mm.

50. The apparatus of claim 47, wherein said apparatus further contains a thermostat device for heating the perfusion liquid.

51. The apparatus of claim 47, wherein said endothelium-protective perfusion solution is any one as defined in any one of claims 24-46.

52. Use of an endothelium-protective perfusion solution defined in any one of claims 24-46 for the preservation of endothelium in isolated hollow organs or biological vessels.

53. Use of an endothelium-protective perfusion solution defined in any one of claims 24-46 for maintenance or repair of endothelial tissue in isolated hollow organs or biological vessels.

54. Use of an endothelium-protective perfusion solution defined in any one of claims 24-46 for therapy or prevention of vascular occlusions in isolated hollow organs or biological vessels.

55. The apparatus of claim 47, wherein said endothelium-protective perfusion solution is any one as defined in any one of claims 1-23.

56. Use of an endothelium-protective perfusion solution defined in any one of claims 1-23 for the preservation of endothelium in isolated hollow organs or biological vessels.

57. Use of an endothelium-protective perfusion solution defined in any one of claims 1-23 for maintenance or repair of endothelial tissue in isolated hollow organs or biological vessels.

58. Use of an endothelium-protective perfusion solution defined in any one of claims 1-23 for therapy or prevention of vascular occlusions in isolated hollow organs or biological vessels.
